(19) United States
(12) Patent Application Publication
(10) Pub. No.: US 2013/0320918 A1
(43) Pub. Date: Dec. 5, 2013

(54) ENERGY SUPPLY APPARATUS HAVING A FIRST POWER AS WELL AS A METHOD FOR OPERATING SAID ENERGY SUPPLY APPARATUS

(71) Applicant: Li-Tec Battery GmbH, Kamenz (DE)

(72) Inventors: Johannes OHMER, Gruendau (DE); Erhard SCHLETTERER, Ostfildern (DE); Roland WEIXLER, Kempten (DE); Ulrike STASSEN, Dresden (DE)

(21) Appl. No.: 13/909,769

(22) Filed: Jun. 4, 2013

Related U.S. Application Data
(60) Provisional application No. 61/655,041, filed on Jun. 4, 2012.

(30) Foreign Application Priority Data
Jun. 4, 2012 (DE) 102012011061.8

(51) Int. Cl. H01M 10/42

(52) U.S. Cl. CPC H01M 10/4207
USPC 320/107; 429/90; 429/61; 429/62; 429/50

(57) ABSTRACT

An energy supply apparatus, in particular for static use, particularly in a building, for which one or a plurality of consumer loads is to be supplied at least temporarily with a first power L₁,

having a first number N₁ of battery modules, each of which comprises at least one preferably rechargeable electrochemical cell, wherein the number N₁ is to be chosen so that, taking into account the particular power of each battery module, a total electrical power at least equal to said first power L₁ is deliverable to the consumer load, with a second number N₂ of battery modules, each of which comprises at least one preferably rechargeable electrochemical cell, wherein the number N₂ is to be chosen so that, taking into account the particular power of each battery module, a total electrical power at least equal to a power ΔL is deliverable to the consumer load.

The present invention relates to an energy supply apparatus having a first power as well as a method for operating said energy supply apparatus. The invention is described in the context of lithium-ion cells for powering a static consumer load. It should be noted that the invention may also be used regardless of the construction type of the cell, the cell chemistry or the type of powered consumer load.

Energy supply apparatuses with several battery modules for the supply of consumer loads with electrical power are known in the prior art. It can happen that the power requirements of a consumer load, at least at times, cannot be fulfilled.

The temporarily insufficient supply of a consumer load by one of the known energy supply apparatuses is regarded to be problematic.

It is an object of the invention to provide an energy supply apparatus which can in large part fulfill the power requirement of a consumer load.

The object is achieved by means of an energy supply apparatus according to claim 1. Claim 13 describes a battery with at least two electrochemical energy storage devices according to the invention. The object is also achieved by means of a manufacturing method according to claim 14 for an electrochemical energy storage device. Preferred further developments of the invention are the subject of the dependent claims.

An energy supply apparatus according to the invention, in particular for static use, particularly in a building, is provided to supply one or a plurality of consumer loads with a first power L₁ at least temporarily. The energy supply apparatus comprises a first number N₁ of battery modules. These battery modules each comprise at least one preferably rechargeable electrochemical cell. The number N₁ is to be chosen so that, taking into account the power of each battery module, a total electrical power at least equal to said first power L₁ is deliverable to the consumer load. The energy supply apparatus comprises a second number N₂ of battery modules. These battery modules each comprise at least one preferably rechargeable electrochemical cell. The number N₂ is to be chosen so that, taking into account the power of each battery module, a total electrical power at least equal to a power ΔL is deliverable to the consumer load. The energy supply apparatus comprises a battery module monitoring device, abbreviated to monitor device, which monitors at least one physical parameter. At least two different operating states of a battery module are detectable by means of this physical parameter. The energy supply apparatus comprises an electrical connection device. Such electrical connection device serves to electrically connect the first number N₁ and the second number N₂ with one or a plurality of consumer loads. The energy supply apparatus comprises at least one electrical switching device. The battery modules can be connected in series and/or in parallel with the electrical connection device by means of the electrical switching device. Said electrical switching device is configured so that each battery module can be electrically isolated from the other battery modules and/or the electrical connection device when the monitor device recognizes that said physical parameter, of which at least one is detected for each battery module, falls outside a range which has been predefined for said physical parameter in particular. The number N₂ and the power from the second number of battery modules is chosen so that the first power L₁ can then be delivered to the consumer load or loads if a predefined number N_{D} of the first or second number of battery modules fail.

If one of the battery modules of the energy supply apparatus fails, be it because of a defect in the battery module or because a physical parameter that has been detected for the battery module is outside a predefined range, said battery module can be isolated from the other battery modules and/or the electrical connection device. Said isolated battery module cannot and does not need to deliver any more energy, i.e. electrical current, to the at least one consumer load. By choosing the number N₂ and the power of the second number of battery modules such that the first power L₁ can be delivered to the consumer load(s), even if at least one of the battery modules from the first or second number of battery modules fails, the supply to one or a plurality of these consumer loads is ensured by means of the energy supply apparatus according to the invention. In particular, the battery modules of the second number act as a reserve in the event of a failure of the battery modules of the first number. Thus the underlying object is solved.

Preferably, the energy supply apparatus comprises a bridging device. The bridging device serves in particular to bridge one isolated battery, preferably when the isolated battery module is part of a series circuit of at least two of the battery modules. Even if one of the battery modules fails, the series circuit's ability to deliver energy is unchanged. This preferred embodiment offers the advantage of increased availability of the energy supply apparatus.

For the purposes of the present invention, the term energy supply apparatus is understood to mean an apparatus which serves at least temporarily to provide one or a plurality of consumer loads with an electrical first power L₁.

For the purposes of the present invention, a consumer load is understood to mean a device which is independent from the energy supply apparatus and which draws power at least temporarily from said energy supply apparatus.

For the purposes of the present invention, the total electrical power [kW] is understood to mean the electrical power which can be drawn, in particular simultaneously, by one or a plurality of the consumer loads from the energy supply apparatus (power requirement).

For the purposes of the present invention, a first electrical power is understood to mean at least the power [kW] which at least temporarily, preferably at least for 1 hour, can be delivered by the energy supply apparatus (deliverable power). The first power corresponds at least to the total power to be supplied to the consumer load. The ratio q between the first power L1 and the total power L_{g} (q=L₁/L_{g}) is preferably at least 1.05, more preferably at least 1.1, more preferably at least 1.2, more preferably at least 1.5, more preferably at least 2.

For the purposes of the present invention, a battery module is understood to mean a device which serves in particular to store energy, and which serves in particular to deliver energy. To this end, the battery module comprises one, two or more preferably rechargeable, electrochemical cells. Said electrochemical cell is configured to store chemical energy, to convert chemical energy into electrical energy and to deliver electrical energy at least temporarily. Preferably the electrochemical cell is designed to receive electrical energy and convert it into chemical energy. Preferably at least two of these cells are connected in series or parallel. The battery module preferably comprises two module terminals of differing polarity, to which is applied, at least temporarily, the voltage of the interconnected cells. According to a first preferred embodiment, at least four of these cells are connected in series. This preferred embodiment offers the advantage that the total voltage of the interconnected cells is increased. According to a second preferred embodiment, at least two of these cells are connected in series. This preferred embodiment offers the advantage that the charging capacity i.e. energy capacity is increased.

The battery modules of the energy supply apparatus can be assigned to the first number N₁ or the second number N₂ of battery modules. The particularly interconnected battery modules of the first number can at least temporarily, preferably for a period of at least 1 h, deliver at least the power L₁. The particularly interconnected battery modules of the second number can at least temporarily, preferably for a period of at least 1 h, deliver at least the power ΔL. Preferably a plurality of battery modules of the first number are connected to one another. In this case N₁ and N₂ are each chosen from the group of natural numbers. Preferably N₁ is at least 2 and N₂ is at least 1. According to a first preferred embodiment, at least two battery modules of the first number are connected in series for increased total voltage of said battery modules. According to a second preferred embodiment, at least two battery modules of the first number are connected in parallel. This preferred embodiment offers the advantage of an increased total current.

According to the invention, a predefined number N_{D} of battery modules can fail without the delivery of the electrical first power L₁ by the energy supply apparatus being impaired. Thus the predefined number N_{D} is chosen from the group of natural numbers. The predefined number N_{D} is preferably at least 1, more preferably at least 2, more preferably at least 5, more preferably at least 10, more preferably at least 20.

For the purposes of the present invention, an operating state of one of the battery modules is characterized by at least one or a plurality of physical parameters of the battery module or one of the cells of the battery module, in particular a predetermined combination of at least two or more of said physical parameters. Preferably, a distinction can be made between a supply state of one of these battery modules and a failure state, whereby in the failure state no electrical energy should be exchanged with the particular battery module. In particular when the monitor device recognizes that said physical parameter, of which at least one is detected for each battery module, is outside a predefined range, the monitor device assumes a failure state of the associated battery module. When in particular the monitor device recognizes that the temperature of one of these battery modules exceeds a predetermined temperature for the period of a first time interval, then the monitor device assumes a failure state of the battery module.

For the purposes of the present invention, a battery module monitor device is understood to mean a device which in particular serves to monitor at least one physical parameter. At least two different operating states of one of the battery modules are ascertainable by means of said physical parameter. Preferably the supply state of one of these battery modules is distinguishable from the failure state by means of said physical parameter. Preferably the battery module monitor device is designed as an electronic assembly, particularly preferably as an application specific integrated circuit or programmable logic controller. The battery module monitor device is preferably configured to operate at least one switching element in one of these electrical circuit devices.

For the purposes of the present invention, a physical parameter is understood to mean a characteristic variable or characteristic property of one of the battery modules or one of the cells, which in particular:
allows a conclusion to be made concerning a supply state of the battery module or of the cell and/or
allows a conclusion to be made concerning a failure state of the battery module or of the cells, and/or
can be determined by means of a measuring device, whereby the measuring device can make a signal available at least temporarily, preferably an electrical voltage or an electrical current, and/or
can be processed by a control device, in particular by a battery module monitor device, and in particular can be related with a target value, in particular can be related with another one of the detected physical parameters, and/or
Enables information concerning:
the electrical voltage of the battery module (module voltage), the electrical current drawn from the battery module (module current), the integrity of the battery module, the charge state of the battery module, a temperature of the battery module (module temperature), an internal pressure of the battery module (battery pressure), the existence of a foreign substance, in particular from the surroundings of the battery module, a presence of a substance in particular of one of the cells, in particular an escape of said substance, a cell voltage, a cell current, a cell temperature, an internal pressure of the cell, the integrity of a cell, the release of a substance from the cell, and/or the charge state of one of the cells, and/or
can prompt a switching of the battery module to another operating state, in particular from the supply state to the failure state,
allows the recognition of a switching of the battery module from the supply state to its failure state.

For the purposes of the present invention, an electrical connection device is understood to mean a device which in particular provides the electrical connection of one or a plurality of the battery modules with one or a plurality of said consumer loads. Electrical power, in particular the first power, can be delivered at least temporarily from the energy supply apparatus to the consumer load(s) by means of the electrical connection device. Preferably the electrical connection device comprises at least two electrical apparatus terminals. Preferably the battery modules of the energy supply apparatus can be connected with the electrical connection device by means of the electrical switching device. Preferably the device terminals can be connected to at least one of said consumer loads.

For the purposes of the present invention, a switching device is understood to mean a device which is particularly configured:
for the breakable electrical contact of at least one or a plurality of said battery modules, and/or
for interconnecting the battery modules in series and/or parallel, and/or
for the breakable electrical connection of the interconnected battery modules with the electrical connection device, and/or
to conduct electrical current at least temporarily between the electrical connection device and at least one of said battery modules, and/or
for the isolation of at least one of said battery modules from the remaining battery modules of the energy supply apparatus, in particular when a physical parameter that has been detected for one of said battery modules is outside a predefined range and/or
for the isolation of at least one of said battery modules from the electrical connection device, in particular when a physical parameter that has been detected for one of said battery modules is outside a predefined range.

The electrical switching device comprises at least one or a plurality of module terminal elements. The module terminal element is configured for the connecting of one of said module terminals, preferably corresponding to a plug or socket.

Preferably, the switching device comprises at least one current conducting device, preferably two current conducting devices of differing polarity.

Said current conducting devices serve to provide the conducting of electrical current between two of the battery modules or between one of the battery modules and the electrical connection device. Preferably at least one or a plurality of these current conducting devices is designed as a particularly metallic conductor rail, band or cable. Preferably at least one or a plurality of the current conducting devices is releasably or materially connectable with one of the apparatus terminals. Preferably at least one of these current conducting devices includes at least one of said module terminal elements, in particular preferably at least one of said module terminal elements per battery module to be connected.

Preferably, the electrical switching device comprises at least one or a plurality of switching elements. The switching element is particularly designed
for the breakable electrical connection of one of said battery modules with one of the current conducting devices, and/or
for the breakable electrical connection of one of said current conducting devices with the electrical connection device, and/or
for the breakable electrical connection of one of said module terminal elements with one of said current conducting devices.

Preferably, the switching element is switchable between
one of said battery modules and one of said current conducting devices, and/or
one of said module terminals and one of said module terminal elements, or
one of said current conducting devices and said electrical connection device, or
one of said module terminals and one of said apparatus terminals of the same polarity, at least indirectly, or
one of said current conducting devices and one of said apparatus terminals.

Preferably, at least one of said switching elements is integrated into one of said module terminal elements. Preferably one or a plurality of said switching elements is a controllable switch, protector, relay, or thyristor.

Preferably, the electrical switching device comprises a reverse polarity protection device. Said reverse polarity protection device counteracts an erroneous pole reversal during the contacting of one of said battery modules. Preferably the reverse polarity protection device prevents contacting of one of said battery modules by not allowing at least one of said module terminals of the first polarity to be connected to module terminal elements of the second polarity. According to a first preferred embodiment, the reverse polarity protection device is configured with a first extension at one of said module terminal elements and with a second extension at one of said module terminals, wherein said module terminal element and said module terminal have the same polarity. According to a second preferred embodiment, the reverse polarity protection device is configured with a protrusion and an opening to suit said protrusion. Preferably the protrusion is part of the electrical switching device and the opening is part of the battery module, or vice versa. The protrusion and the opening are designed so that the protrusion fits only into the opening with the correct orientation of the poles of the battery module.

As well as the above function, the protrusion prevents a mechanical connection of module terminal element and module terminal.

A first preferred further development of the electrical switching device serves to provide the connection of battery modules which are connected in parallel, with the electrical connection device. Said electrical switching device includes at least one or two of said current conducting devices. At least one or two of these current conducting devices are preferably designed as current rail. The current conducting device comprises one of said module terminal elements for each battery module to be connected. Preferably one of said apparatus terminals is mechanically connected, preferably screwed, riveted, or welded, or integrally formed with said current conducting device. This further development offers the advantage that the mechanical stability of the electrical switching device is increased. This further development offers the advantage that the connecting together of at least two of said battery modules is simplified.

A second preferred further development of the electrical switching device serves to provide the connection of battery modules, which are connected in series, with the electrical connection device. The electrical switching device includes at least one of said current conducting devices. The current conducting device is preferably configured as a current rail. The current conducting device includes at least one of said module terminal elements. Furthermore, said current conducting device comprises a second of said module terminal elements or the current conducting device is at least indirectly electrically connected with one of said apparatus terminals. This further development offers the advantage that the mechanical stability of the electrical switching device is increased. This further development offers the advantage that the connecting together of at least two of said battery modules is simplified.

According to a third preferred further development of the electrical switching device, at least one of said battery modules, in particular one of said module terminals, is connected by means of one of said switching elements with one of said module terminal elements. This preferred further development offers the advantage that said battery module is isolatable from the other battery modules and/or from the electrical connection device, in particular in the event of a defect in the battery module or when said physical parameter, of which at least one is detected for each battery module, is outside a predefined range. It is advantageous to combine said further development with one of the first or second further developments.

For the purposes of the present invention, the term bridging device is understood to mean a device which in particular serves the purpose of bridging an isolated battery module, in particular an isolated battery module of a series circuit of several battery modules, in particular when said physical parameter, of which at least one is detected for each battery module, is outside a predefined range, in particular when the isolated battery module has assumed its failure state.

According to a first preferred embodiment, the bridging device is connected between the two module terminals of differing polarity of the particularly isolated battery module. Said bridging device is designed to short-circuit said module terminals. To this end the bridging device comprises at least one controllable switch. Preferably the bridging device comprises a discharge resistor by means of which the battery module can be discharged at least partially. This preferred embodiment offers the advantage that a current path for discharging the isolated battery module is created at the same time as the bridging.

According to a second preferred embodiment, the bridging device is connected between two of said module terminal elements of differing polarity for the same battery module. Said bridging device is designed to short-circuit said module terminal elements. To this end the bridging device comprises at least one controllable switch. This preferred embodiment offers the advantage that the energy remains contained in the isolated battery module when at least one of the module terminals is isolated from the interconnected cells.

According to a preferred embodiment, the energy supply apparatus comprises a measuring device. The measuring device is particularly configured to detect at least one or a plurality of said physical parameters. The measuring device is in particular configured to provide at least one or a plurality of measurement values, wherein at least one said measurement value is representative of the detected physical parameter. Preferably at least one or a plurality of said measurement values can be provided as a predetermined electrical voltage or as a predetermined electrical current.

The measuring device includes at least one, preferably a plurality, of measuring probes, in particular for different of said physical parameters. Preferably the measuring device includes a plurality of these measuring probes, said probes being allocated to different battery modules, particularly preferably for measuring one of said physical parameters of one of said battery modules or at least one of its cells. Preferably the measuring device, in particular at least one of its measuring probes, is configured to detect an oxidation product and/or smoke.

Preferably the measuring device comprises a probe switcher which is signally connected with a plurality of said measuring probes and which is configured for the purpose of interrogating and/or controlling said measuring probes, in particular sequentially.

Preferably the measuring device comprises at least one or a plurality of measuring probe terminals which serve the purpose of making contact with the different measuring probes. Particularly preferably, a plurality of said measuring probe terminals are unified at one multi-pole terminal.

Preferably, the detected measurement values are storable in a data storage means, particularly preferably each value being stored with a value which is representative of the point in time when the associated measurement value was taken.

This preferred embodiment offers the advantage that knowledge about the operational state of each battery module can be gained from said measurement value.

According to a preferred embodiment, the energy supply apparatus comprises a module accommodation device. The module accommodation device is particularly configured to accommodate, in particular to removably accommodate, at least one or a plurality of said battery modules, and preferably to accommodate, in particular removably accommodate, all of said battery modules. Preferably, said electrical switching device is particularly configured for the purpose of the contacting of the battery module by the module accommodation device. When a battery module is accommodated by the module accommodation device and is contacted by the switching device, in particular by means of a plurality of said module terminal elements, then the exchange is possible of signals and/or electrical power, i.e. electrical energy, with said battery module. Preferably the electrical switching device, in particular its current rails, comprises two module terminal elements per battery module for the exchange of electrical power, i.e. electrical energy, with said battery module. Preferably at least some of said module terminal elements are electrically connected with each other so that the battery modules accommodated by the module accommodation device are interconnected in series and/or in parallel. The module accommodation device preferably comprises at least two or a plurality of shelves for said battery modules. This preferred embodiment offers the advantage that the grouping of a plurality of said battery modules is simplified.

According to a first preferred further development, the module accommodation device is configured as a rack with at least two or more shelves for at least two or more said battery modules, particularly with shelves arranged one above the other. Preferably, said shelves comprise pull-out support surfaces with one support surface each for at least one of said battery modules. Said shelves are particularly preferably designed as drawers. This preferred further development offers the advantage that the battery modules are easier to access for exchanging.

According to a second preferred further development, the module accommodation device is designed according to an electrical cabinet with shelves, in particular arranged one above the other, for a plurality of said battery modules. This preferred further development offers the advantage that the electrical switching devices are secured against unauthorized access.

According to a preferred embodiment, the electrical switching device comprises at least one or a plurality of thermal protection devices. The at least one thermal protection device is configured to limit heat flow between two, particularly two adjacent, of said battery modules. Preferably, the at least one thermal protection device is configured in the shape of a board or mat. The thermal protection device preferably comprises an expandable material, particularly preferably Palstop®, which is configured so that its specific volume [cm³/g] increases from a least temperature of the thermal protection device, wherein the thermal conductivity of the thermal protection device decreases. The thermal protection device preferably comprises a gel, particularly preferably Firesorb®, which serves the purpose of forming a gel with water on a surface of the thermal protection device. The gel serves the purpose of protecting the thermal protection device in particular in the event of a fire in the surroundings of the thermal protection device and/or in the surroundings of one of the battery modules, in particular one of the adjacent battery modules. This preferred embodiment offers the advantage that the protection during a fire of one of said battery modules adjacent to said thermal protection device is improved.

According to a preferred embodiment, the monitor device is designed to activate at least one or a plurality of said electrical switching devices, preferably to activate at least one or a plurality of said switching elements. Furthermore the monitor device is designed to receive at least one or a plurality of said measurement values. The monitor device is particularly configured to relate at least one or a plurality of said measurement values with another of said measurement values, with a comparison value or a comparison interval, and to provide at least one result of a relation or a logical value. The result of a relation or logical value serves in particular the purpose of providing information about an operating state of at least one of said battery modules. The monitor device is configured to recognize whether a detected one of said physical parameters is outside a predefined range, preferably as a consequence of relating the associated measurement value with a comparison value or a comparison interval. The monitor device is preferably configured to relate a plurality of said detected measurement values. The monitor device is preferably configured in particular to deduce the failure state based on at least one or a plurality of said measurement values or one of said results of a relation. The monitor device is preferably configured to activate at least one or a plurality of said bridging devices, in particular when one of said detected physical parameters is outside a predefined range. The monitor device is preferably configured to assume the failure state, when said physical parameter, of which at least one is detected for each battery module, is outside a predefined range.

The monitor device is preferably signally connected with a data storage means, in which comparison values, comparison intervals and/or predefined ranges for physical parameters can be saved. The monitor device is preferably configured to save measurement values and results of a relation in said data storage means. This preferred embodiment offers the advantage that the monitor device is able to ascertain the failure state.

According to a preferred embodiment, the energy supply apparatus comprises at least one preferably bidirectional voltage converter. Said voltage converter is connected between at least one of said battery modules and the electrical connection device. Said voltage converter is preferably connected between two of said current conducting devices of differing polarity and said electrical connection device. Said voltage converter is configured to provide, at least temporarily, a predetermined d.c. voltage or a predetermined a.c. voltage, in particular for the purpose of supplying a consumer load. This preferred embodiment offers the advantage that when the total voltage of the series-connected battery modules of the first number does not equal the nominal voltage of the consumer load supplied by the energy supply apparatus, the energy supply apparatus is able to provide the rated voltage after converting the total voltage by means of the voltage converter. This preferred embodiment offers the advantage that when one of the battery modules of a series circuit of battery modules, in particular of the first number, is isolated and bridged, the energy supply apparatus is able to provide the rated voltage after converting the total voltage of the battery modules by means of the voltage converter.

According to a preferred first further development, the voltage converter is configured as an inverter. This preferred further development offers the advantage that when the consumer loads supplied by the energy supply apparatus require an a.c. voltage, the energy supply apparatus is able to provide the required a.c. voltage.

According to a second preferred further development, the voltage converter is configured to provide at least temporarily a predetermined charge voltage and/or a predetermined charge current, in particular for the charging of at least one of said battery modules. This preferred further development offers the advantage that electrical energy or power for charging can be delivered to the battery modules by means of the electrical connection device and the voltage converter. This preferred further development offers the further advantage that the electrical voltage of the delivered electrical energy or power can be converted by means of the voltage converter to suit the required charge voltage. It is advantageous to combine the second further development with the first further development.

According to a third preferred further development, the voltage converter is configured as a rectifier. This preferred further development offers the advantage that a supplied a.c. voltage is suitably converted by means of the voltage converter into a predefined d.c. voltage for charging of the electrochemical cells of the battery modules. It is advantageous to combine the third further development with the first or second further development.

According to a preferred embodiment, the energy supply apparatus comprises at least one extinguishing device. This extinguishing device serves the purpose of counteracting a fire in at least one of said battery modules. The at least one extinguishing device is designed to deliver at least temporarily an extinguishing agent in particular to one of said battery modules, in particular when the monitor device recognizes that said physical parameter, of which at least one is detected for each battery module, is outside a predefined range, preferably when the measuring device detects an oxidation product and/or smoke. The extinguishing agent preferably includes an inert fluid, particularly preferably water, carbon dioxide, and/or nitrogen. The extinguishing agent preferably includes a foam and/or a powder. The extinguishing agent preferably includes a gel forming agent, particularly preferably Firesorb®. This preferred embodiment offers the advantage that a fire in at least one of said battery modules can be counteracted.

According to a first preferred further development, the extinguishing device includes an extinguishing agent store. The extinguishing agent store serves in particular the purpose of storing the extinguishing agent and to deliver it when required, in particular to deliver it on command from the monitor device. Preferably the extinguishing agent is at least temporarily under positive pressure in the extinguishing agent store. Thus after opening of the extinguishing agent store, the extinguishing agent can escape due to the positive pressure. This has the associated advantage that a pump for delivering the extinguishing agent is obviated.

Furthermore the extinguishing device comprises at least one extinguishing agent channel. The extinguishing agent channel serves the purpose of supplying the extinguishing agent to at least one of said battery modules, in particular from the extinguishing agent store. Preferably the extinguishing device comprises at least one controllable extinguishing agent valve for each extinguishing agent channel. The extinguishing agent valve is preferably controllable by the monitor device. This preferred further development offers the advantage that the delivery of extinguishing agent can be targeted at an in particular failed battery module.

According to a second preferred further development, said extinguishing agent valve is controllable by means of a thermo switch. By means of the thermostat, the extinguishing agent valve can even be opened in the event of failure of the monitor device following an increase in ambient temperature. This preferred further development offers the advantage of increased safety. This further development can be combined with the first further development.

According to a third further development, one or a plurality of said extinguishing agent channels comprise at least one or a plurality of closable extinguishing agent vents. Said extinguishing agent vents are designed to allow the extinguishing agent to pass to one of said battery modules. Preferably one or a plurality of said extinguishing agent vents opens into one of said battery modules. Preferably said extinguishing agent vents are each sealed by one of said controllable extinguishing agent valves. Each of these extinguishing agent vents is preferably sealed by a body that breaks with increasing temperature and opens the extinguishing agent vent. The extinguishing agent vent is particularly preferably a sprinkler head of a sprinkler system with a glass vial or polymer rod wherein the glass vial or polymer rod breaks above a predetermined temperature and opens said extinguishing agent vent. This further development can be combined with one of the first or second further developments.

According to a preferred embodiment, the energy supply apparatus comprises an extraction device, in particular an extraction device for an oxidation product and/or smoke. Said extraction device is connected with at least one or a plurality of said battery modules. The extraction device preferably comprises at least one or a plurality of extraction channels for the transport of a fluid. The extraction device particularly preferably comprises a central extraction channel into which a plurality of extraction channel segments flows, whereby said extraction channel segments are connected with different battery modules. Preferably, said extraction device comprises a fluid conveying device for a fluid, particularly preferably a pump. Preferably the extraction device comprises a fluid cleaning device, which preferably cleans the extracted fluid before its entry into the fluid conveying device. Said fluid cleaning device is designed to clean the extracted fluid, before said extracted fluid enters into the surroundings. To this end the fluid cleaning device comprises at least one filter and/or air cleaner. The extraction device can be activated by the monitor device, in particular when the monitor device recognizes that said physical parameter, of which at least one is detected for each battery module, is outside a predefined range, preferably when the measuring device detects an oxidation product and/or smoke. The extraction device preferably can be activated by one of said thermostats. The extraction device preferably is activated only with a predetermined time delay after the extinguishing device. Thus the activation time of the extinguishing agent is controllable. This preferred further development offers the advantage of increased safety, particularly for the surroundings of the energy supply apparatus.

According to a preferred embodiment, the energy supply apparatus comprises a communication device. Said communication device is designed to communicate at least one or a plurality of said physical parameters, in particular according to requirements, in particular periodically, in particular upon the existence of the failure state. Said communication device is designed to communicate at least one or a plurality of said physical parameters to an in particular higher level control device at least indirectly, in particular on command from said control device. Preferably, said communication device is designed to communicate or to transmit the fact that at least one of said physical parameters is outside a predefined associated range. Said communication device is preferably designed as a beeper, light emitting diode, serial interface, Ethernet interface, infra-red interface, GPS device, GSM module, short range device or transponder. The communication device preferably comprises a data interface, an antenna, a means of illumination or a loudspeaker. Preferably, said communication device can be activated by the monitor device. This preferred embodiment offers the advantage that at least one physical parameter or one operating state can be made known remotely, in particular to an operator of the energy supply apparatus.

According to a preferred further development, said communication device is designed to send, at least temporarily, and in particular periodically, a predetermined first signal which indicates an error-free function of the energy supply apparatus. This preferred further development offers the advantage that the absence of said first signal can be interpreted as a warning.

According to a preferred embodiment, the energy supply apparatus comprises an auxiliary energy supply device. The auxiliary energy supply device is designed to receive energy in particular from at least one of said battery modules and to store said energy. The auxiliary energy supply device is designed to deliver energy in particular when said monitor device recognizes that said physical parameter, of which at least one is detected for each battery module, is outside a predefined range, in particular when a supply voltage for the supply of the monitor device falls below a lower limit. The auxiliary energy supply device is designed to supply with electrical energy, at least temporarily, at least said monitor device, said measuring device, said extinguishing device and/or said communication device, preferably when at least one of said battery modules fails. Preferably the auxiliary energy supply device temporarily supplies the monitor device, the measuring device, the extinguishing device, and particularly preferably the communication device. Preferably, said auxiliary energy supply device is connected between the monitor device and at least one of said battery modules, particularly preferably between the monitor device and the interconnected battery modules. Preferably the auxiliary energy supply device operates as an uninterruptible power supply. Particularly preferably, the supply of the monitor device with energy takes place exclusively by means of the auxiliary energy supply device which has been connected between the monitor device and at least one of said battery modules. This preferred embodiment offers the advantage that the operational safety of the energy supply apparatus is improved.

According to a preferred further development, the auxiliary energy supply device is designed as a capacitive energy storage means and/or as an electrochemical energy storage means. This preferred further development offers the advantage that the integration of the auxiliary energy supply device into the energy supply apparatus is possible with minimal cost. This preferred further development offers the advantage that the exchange of electrical energy with said auxiliary energy supply device is possible.

According to a preferred embodiment, the energy supply apparatus comprises at least one temperature control device. Said temperature control device is designed to at least partially remove heat from at least one of said battery modules, in particular when an maximum temperature of one of said battery modules is exceeded. Preferably the temperature control device is designed to deliver heat to one or a plurality of said battery modules, in particular when a temperature of one of said battery modules falls below a lower limit. The temperature control device is preferably designed to deliver, at least temporarily, a temperature-controlling fluid to said battery module, in particular for the exchange of heat with said battery module. The temperature control device preferably comprises at least one or a plurality of temperature-controlling fluid channels.

Preferably the temperature control device comprises a heat exchanger which is designed to exchange heat with the temperature-controlling fluid, and which is preferably designed to exchange heat with the surroundings of the energy supply apparatus, in particular to deliver heat to the surroundings.

Preferably the temperature control device comprises one fluid conveying device for the temperature-controlling fluid, in particular a pump. By means of said fluid conveying device, the temperature-controlling fluid can be delivered through the at least one temperature-controlling fluid channel.

The fluid conveying device is particularly preferably at least temporarily supplied with energy from at least one of said battery modules.

The temperature-controlling fluid channel preferably comprises at least one fluid channel segment which extends within, in particular through, at least one of said battery modules. The fluid channel segment preferably thermally conductively contacts at least one of the cells. Said fluid channel segment comprises a first end for the entry of the temperature-controlling fluid and, opposite this, a second end for the exit of the temperature-controlling fluid. The fluid channel segment preferably comprises quick couplings which facilitate a change of the battery module and which allow a separation of the fluid channel segments from the temperature-controlling fluid channel. This preferred embodiment offers the advantage that the temperature of at least one of said battery modules can be controlled, in particular so that the temperature of said battery module can be kept within an allowed temperature range.

According to a first preferred further development, the temperature-controlling fluid channel comprises at least one temperature-controlling-fluid vent. Said temperature-controlling-fluid vent serves in particular the purpose of allowing the temperature-controlling fluid to exit out of the temperature-controlling fluid channel, in particular when the monitor device recognizes that said physical parameter, of which at least one is detected for each battery module, is outside a predefined range, preferably when the temperature of one of said battery modules exceeds the maximum temperature, preferably in the event of a fire in the surroundings of the battery module. Preferably the temperature-controlling-fluid vent allows the exit of the temperature-controlling fluid into one of said battery modules. Preferably the temperature-controlling-fluid vent can be opened by means of a controllable valve. Said valve is particularly preferably activated by the monitor device and/or by means of a thermostat. Preferably, said temperature-controlling-fluid vent is sealed by means of a body that breaks with increasing temperature and opens said temperature-controlling-fluid vent. Said temperature-controlling-fluid vent is particularly preferably designed as a sprinkler head of a sprinkler system with a glass vial or polymer rod wherein the glass vial or polymer rod breaks above a predetermined temperature and opens said temperature-controlling-fluid vent. The temperature-controlling fluid preferably includes water and a gelling agent, particularly preferably Firesorb®. This preferred further development offers the advantage of increased operational safety of the energy supply apparatus.

According to a preferred second further development, the temperature control device is, at least in sections, integrally formed with the extinguishing device. The extinguishing agent preferably serves simultaneously as the temperature-controlling fluid. Preferably at least one of said temperature-controlling fluid channels serves also as an extinguishing agent channel, at least in sections. Preferably at least one of said temperature-controlling fluid channels is integrally formed with one of said extinguishing agent channels, at least in sections. The temperature-controlling-fluid vent is preferably positioned inside one of said battery modules. This preferred further development offers the advantage that the equipment costs for extinguishing and temperature controlling are reduced. This preferred further development can be combined with the first preferred further development

According to a preferred embodiment, at least one or a plurality of said battery modules comprises a module housing. The module housing serves in particular to demarcate at least one or a plurality of said cells or said battery modules from the surroundings. The module housing serves in particular to accommodate at least one or a plurality of said cells. The module housing is designed to counteract an uncontrolled exit of a substance from said battery module into the surroundings. Preferably the module housing is designed to counteract an uncontrolled exit of an oxidation product and/or smoke. The module housing is preferably designed to counteract an entry of an undesired substance into the battery module.

Preferably, the module housing is designed as a two part, in particular metallic, housing comprising a module box and a module lid. The module lid and module box are particularly preferably releasably connected to each other, in particular by means of screws, wherein in particular a gasket can be arranged or laid between module lid and module box. This preferred embodiment offers the advantage that an undesired exchange of substances between the surroundings and said battery module is counteracted.

According to a first preferred further development, at least one of said measuring probes is accommodated by said module housing and preferably also attached to the module box. This preferred further development offers the advantage that an undesired movement of the measuring probe is counteracted. A measuring probe terminal is preferably attached to said measuring probe at the module box and accessible from outside the module housing. A plurality of measuring probe terminals is particularly preferably unified at a multi-pole connector, wherein said multi-pole connector in particular is arranged on a wall of the module box. This preferred embodiment offers the advantage of a simplified contacting of in particular a plurality of said measuring probes.

According to a preferred second further development, at least one of said extinguishing agent channels is connected with said module housing, in particular by means of at least one quick coupling at the module box. Said extinguishing agent channel preferably also extends within the module housing. Particularly preferably, said extinguishing agent channel opens into at least one of said extinguishing agent vents of the module housing. Thus an extinguishing agent can be delivered to the battery module, in particular when said monitor device recognizes that said physical parameter, of which at least one is detected for each battery module, is outside a predefined range, preferably when the measuring device detects an oxidation product and/or smoke. This preferred further development offers the advantage that the operating safety of the energy supply apparatus is increased. This further development can be advantageously combined with the first further development.

According to a preferred third further development, at least one of said fluid channel segments extends within or through the module housing. Quick couplings are particularly preferably arranged at the fluid channel segment at the module box. This preferred further development offers the advantage that heat can be delivered to or removed from the battery module. This further development can be advantageously combined with one of the first or second further developments.

According to a preferred fourth further development, at least one of said temperature-controlling-fluid vents is positioned inside the module housing. The temperature-controlling fluid preferably includes water and/or a gelling agent, particularly preferably Firesorb®. This preferred further development offers the advantage that the temperature-controlling fluid can also counteract a fire, whereby the operational safety of the energy supply apparatus is increased. This further development can be advantageously combined with one of the first, second or third further developments.

According to a preferred fifth further development, said extinguishing agent channel and said temperature-controlling fluid channel are integrally formed at least in sections. The temperature-controlling fluid preferably also serves as extinguishing agent. This further development offers the advantage of a reduced cost of manufacture of the battery module. This further development can be advantageously combined with one of the first, second, third or fourth further developments.

According to a preferred sixth further development, two of said module terminals of differing polarity are arranged at a lateral surface or wall of the module housing so that each module terminal can be connected with one of said module terminal elements. This preferred further development offers the advantage that the contacting of the battery module, in particular during its replacement, is simplified. This further development can be advantageously combined with at least one of the first, second, third, fourth or fifth further developments.

According to a preferred seventh further development, at least one controllable circuit breaker is connected between by n the cells of the battery module and one of said module terminals. Said circuit breaker can particularly preferably be controlled by the monitor device. Said circuit breaker is preferably part of the electrical switching device and is particularly preferably integrally formed with one of said switching elements of the electrical switching device. This preferred further development offers the advantage that electrical isolation of the battery module is simplified. This further development can be advantageously combined with at least one of the first, second, third, fourth, fifth or sixth further developments.

According to a preferred eighth further development, the discharge resistor of the bridging device is thermally conductively connected with the module box and/or with one of the temperature-controlling fluid channels, in particular within the module box. This preferred further development offers the advantage that the module housing or temperature-controlling fluid channel can serve as a heat sink for said discharge resistor. This further development can be advantageously combined with at least one of the first, second, third, fourth, fifth, sixth or seventh further developments.

According to a preferred ninth further development, the module housing comprises a pressure relief device with an opening in a wall of the module housing and with a self-closing outlet valve in said opening. The pressure relief device or its opening is preferably connected with the extraction device, in particular with one of said extraction channels. This preferred further development offers the advantage that a positive pressure can be created in the module housing. This preferred further development offers the advantage that the fluid can be channeled and extracted. This further development can be advantageously combined with at least one of the first, second, third, fourth, fifth, sixth, seventh or eighth further developments.

According to a preferred tenth further development, at least one or a plurality of said battery modules comprises a cell connection device. Said cell connection device is designed to interconnect the cells of the battery module. The cell connection device is preferably designed as an array of electrical contacts and electrical conductors, in particular as an array carrier. The electrical contacts are configured for contacting the cell poles, in particular configured as clamps. The electrical conductors are arranged for the electrical connection of the electrical contacts of the battery module's cells in series or in parallel. This further development can be advantageously combined with at least one of the first, second, third, fourth, fifth, sixth, seventh, eighth or ninth further developments.

According to a preferred embodiment, the energy supply apparatus can at least temporarily deliver a first power of at least 1 kW, preferably at least 10 kW, further preferably at least 20 kW, further preferably at least 50 kW, further preferably at least 100 kW, further preferably at least 200 kW, further preferably at least 500 kW, preferably for at least one hour. This preferred embodiment offers the advantage that in particular a domestic building, an industrial plant, a hospital or another group of electrical consumer loads can be at least temporarily supplied with energy. This preferred embodiment offers the advantage that the energy supply apparatus can serve in particular the purpose of an energy storage buffer of a wind turbine plant, hydroelectric plant, or thermal power plant.

According to a preferred embodiment, the energy supply apparatus can provide energy of at least 10 kWh, further preferably at least 20 kWh, further preferably at least 50 kWh, further preferably at least 100 kWh, further preferably at least 200 kWh, further preferably at least 500 kWh, further preferably at least 1 MWh, further preferably at least 2 MWh, further preferably at least 5 MWh. This preferred embodiment offers the advantage that in particular a domestic building, an industrial plant, a hospital or another group of electrical consumer loads can be at least temporarily supplied with energy. This preferred embodiment offers the advantage that the energy supply apparatus can serve in particular the purpose of an energy storage buffer of a wind turbine plant, hydroelectric plant, or thermal power plant.

According to a preferred embodiment, at least one or a plurality of the cells of at least one or a plurality of said battery modules comprises a charge capacity of at least 3 Ampere-hours [Ah], further preferably at least 5 Ah, further preferably at least 10 Ah, further preferably at least 20 Ah, further preferably at least 50 Ah, further preferably at least 100 Ah, further preferably at least 200 Ah, further preferably at most 500 Ah. This preferred embodiment offers the advantage of an improved operating time of the consumer load to be supplied by the energy supply apparatus.

According to a preferred embodiment, at least one or a plurality of the cells of at least one or a plurality of said battery modules can produce, at least temporarily, preferably for at least one hour, a current of at least 50 A, further preferably at least 100 A, further preferably at least 200 A, further preferably at least 500 A, further preferably at most 1000 A. This preferred embodiment offers the advantage of an improved performance of the consumer load to be supplied by the energy supply apparatus.

According to a preferred embodiment, at least one or a plurality of the cells of at least one or a plurality of said battery modules can provide, at least temporarily, a voltage, in particular an open circuit voltage of at least 1.2 V, further preferably at least 1.5 V, further preferably at least 2 V, further preferably at least 2.5 V, further preferably at least 3 V, further preferably at least 3.5 V, further preferably at least 4 V, further preferably at least 4.5 V, further preferably at least 5 V, further preferably at least 5.5 V, further preferably at least 6 V, further preferably at least 6.5 V, further preferably at least 7 V, further preferably at most 7.5 V. Particularly preferably, the secondary cell includes lithium and/or lithium ions. This preferred embodiment offers the advantage of an improved energy density of the energy supply apparatus.

According to a preferred embodiment, at least one or a plurality of the cells of at least one or a plurality of said battery modules can be operated, at least temporarily, in particular for at least one hour, at an environmental temperature between −40° C. and 100° C., further preferably between −20° C. and 80° C., further preferably between and −10° C. and 60° C., further preferably between 0° C. and 40° C. This preferred embodiment offers the advantage of an as unlimited as possible installation or use of the energy supply apparatus for the supply of a consumer load, in particular an automotive vehicle or a static plant or machine.

According to a preferred embodiment, at least one or a plurality of the cells of at least one or a plurality of said battery modules has a gravimetric energy density of at least 50 Wh/kg, further preferably at least 100 Wh/kg, further preferably at least 200 Wh/kg, further preferably less than 500 Wh/kg. The electrode module preferably comprises lithium ions. This preferred embodiment offers the advantage of an improved energy density of the energy supply apparatus.

According to a preferred embodiment, at least one or a plurality of the cells of at least one or a plurality of said battery modules is provided for use in a static battery, in particular an energy storage buffer, as an equipment battery, industrial battery or starter battery. Preferably the charge capacity of the cell for said applications amounts to at least 3 Ah, particularly preferably at least 10 Ah. This preferred embodiment offers the advantage of an improved supply of a static consumer load, in particular of a statically mounted electrical motor.

According to a preferred embodiment, at least one or a plurality of the cells of at least one or a plurality of said battery modules includes a separator.

According to a preferred embodiment, the at least one separator which does not conduct electrons or does so only weakly, consists of an at least partially material-permeable substrate. The substrate is preferably coated on at least one side with an inorganic material. An organic material is preferably used as the at least partially material-permeable substrate which preferably is configured as a non-woven fabric. The organic material which preferably comprises a polymer and particularly preferably a polyethylene terephthalate (PET), is coated with an inorganic, preferably ion-conducting, material which is further preferably ion-conducting in a temperature range −40° C. to 200° C. The inorganic material preferably contains at least one compound from the group of oxides, phosphates, sulphates, titanates, silicates, aluminosilicates having at least one of the elements Zr, Al, Li, particularly preferably zirconium oxide. Zirconium oxide in particular serves to provide the material integrity, nanoporosity and flexibility of the separator. Preferably the inorganic, ion-conducting material comprises particles with a maximum diameter below 100 nm. This embodiment offers the advantage that the stability of the electrode module at temperatures over 100° C. is improved. Such a separator is sold under the trade name “Separion” from Evonik AG in Germany, for example.

According to a second preferred embodiment, the at least one separator which does not conduct electrons or does so only weakly, but is ion-conducting, is made at least predominantly or completely from a ceramic, preferably from a ceramic oxide. This embodiment offers the advantage that the stability of the electrode module at temperatures over 100° C. is improved.

According to a preferred embodiment, the energy supply apparatus comprises a module container which serves in particular the purpose of accommodating a battery module, in particular a failed battery module, in particular during an undesired chemical reaction of one of the materials or of one of the components of the battery module. The module container preferably serves the purpose of counteracting an exit of a material of the accommodated battery module, or of an oxidation product and/or smoke in the surroundings of the energy supply apparatus. The module container preferably serves the purpose of safeguarding the surroundings from the effects of a severe, in particular destructive, chemical reaction of a part of the battery module.

The module container preferably comprises a closable opening through which the battery module can be introduced into the module container. The opening and/or closing of the opening are preferably controllable by the monitor device. The module container preferably comprises at least regionally a thermal conductivity of less than 0.5 W/mK, further preferably less than 0.1 W/mK. The module container preferably comprises at least regionally a thermally insulating layer, particularly preferably glass wool, mineral wool, a mineral filler, a fibrous material, a foam sheet, a polymer foam and/or PU-foam. This preferred embodiment offers the advantage of an increased safety for the surroundings of the energy supply apparatus. This preferred embodiment offers the advantage that the protection of the surroundings from materials from one of the battery modules, from the product of a reaction with a material from one of the battery modules and/or from heat from said reaction, is improved.

According to a first preferred further development, the module container is connected to the extinguishing device. A wall of the module container preferably includes one of said extinguishing agent vents. Said extinguishing agent vent is preferably at least temporarily closed by means of one of said extinguishing agent valves. Preferably, said extinguishing agent valve can be opened by the monitor device, particularly preferably by one of said thermostats. Preferably the extinguishing agent vent is closed with a sealing body. Said sealing body is configured to break above a minimum temperature and open up the extinguishing agent vent. By the possibility of having extinguishing agent guided into the module container, in particular above a minimum temperature, an undesired chemical reaction of a material or one of the components of the battery module can be inhibited. This preferred further development offers the advantage of increased safety.

According to a second preferred further development, the module container is connected to the temperature control device. Preferably at least one of said temperature-controlling fluid channels flows into said module container. One wall of the module container preferably includes one of said temperature-controlling-fluid vents. Preferably, said temperature-controlling-fluid vent is at least temporarily closed off by a controllable valve. This controllable valve can preferably be opened by the monitor device, particularly preferably by one of said thermostats. The temperature-controlling-fluid vent is preferably sealed with a sealing body. Said sealing body is designed to break above a minimum temperature and open the temperature-controlling-fluid vent. By the possibility of having temperature-controlling fluid guided into the module container, in particular above a minimum temperature, an undesired chemical reaction of a material or one of the components of the battery module can be inhibited. This preferred further development offers the advantage of increased safety. This further development can be advantageously combined with the first preferred further development.

According to a third preferred further development, the module container is connected to the extraction device. The extraction device preferably includes one of said fluid conveying devices, in particular for a fluid to be extracted from the module container. The extraction device preferably includes one of said fluid cleaning devices, in particular for the purpose of cleaning a fluid which has been extracted from the module container. By substantially removing the extracted fluid from the module container and cleaning said fluid after it has left the fluid cleaning device, an exit of an undesired material into the surroundings of the module container after opening of the module container is counteracted. This preferred further development offers the advantage of increased safety. This further development can be combined with one of the first or second preferred further developments.

According to a preferred embodiment, the energy supply apparatus comprises a module exchange device. This module exchange device serves the purpose of removing an in particular first of said battery modules from one of said module accommodation devices and/or installing an in particular second of said battery modules in one of said module accommodation devices, in particular into the same module accommodation device. Said module exchange device is designed to remove an in particular isolated and/or failed battery module in particular from one of said shelves of one of said module accommodation devices. This module exchange device is designed to deliver one of said battery modules to one of said module accommodation devices, in particular to install it on a shelf of one of said module accommodation devices, in particular on the shelf from which the failed battery module was previously removed. This module exchange device is preferably signally connected with said monitor device.

Said module exchange device preferably comprises a grab which is designed to releasably pick up one of said battery modules, at least temporarily. The module exchange device preferably comprises a grab-guiding device for guiding and moving the grab relative to the remaining battery modules or module accommodation devices.

The module exchange device is designed:
to receive a signal from the monitor device, wherein an identifier is added to the signal, said identifier being either for the battery module which is to be picked up, of one of said module accommodation devices, or for the associated shelf,
to collect the battery module corresponding to the identifier, hereinafter referred to as first battery module, and to remove it from the module accommodation device,
to store the first battery module in an examination area, wherein said examination area is preferably designed to examine the first battery module,
to store the first battery module in one of said module containers,
to receive a second of said battery modules which does not yet belong to said energy supply apparatus, and which is not yet connected with said energy supply apparatus,
to deliver in particular the second battery module to a shelf of one of said module accommodation devices, in particular to the shelf corresponding to the identifier,
to install the second battery module onto one of said shelves, in particular onto the shelf corresponding to the identifier.
upon installation of the second battery module, to preferably install its module terminals into corresponding module terminal elements, in particular to prepare a contacting of the second battery module, in particular to achieve said contacting,
upon installation of the second battery module, to preferably contact its measuring probe(s), in particular to connect its measuring probe terminals with corresponding signal leads,
upon installation of the second battery module, to preferably connect its quick couplings with at least one of said extinguishing agent channels and/or with one of said temperature-controlling fluid channels.
upon installation of the second battery module, to preferably prepare its connection with at least one of said signal leads, in particular to achieve said connection.

Said module exchange device offers the advantage that a first battery module can be removed and a second battery module can be installed without human assistance.

According to a preferred embodiment, the energy supply apparatus comprises at least two or more battery module arrays which each comprise a first of said electrical switching devices as well as a plurality of said battery modules. These battery modules are connectable in series and/or in parallel with one another by means of said first electrical switching device. These battery modules of at least one of said battery module arrays are preferably accommodated by one of said module accommodation devices.

Furthermore this preferred embodiment comprises a second of said electrical switching devices. Said second electrical switching device can be connected with said electrical connection device and with said battery module array. At least one of said battery module arrays can be isolated from the second switching device, in particular by means of the second of said switching elements, in particular on command from the monitor device. At least one of said battery module arrays is connectable with the second electrical switching device, in particular by means of said second switching element, in particular on command from the monitor device, in particular when one of said battery module arrays is isolated from the second electrical switching device.

Said second electrical switching device preferably comprises at least two or more of said current conducting devices. At least two of said second current conducting devices preferably have a different polarity and are connected with the apparatus terminals in particular by means of at least one of said second electrical switching devices.

According to a preferred further development, these two current conducting devices of differing polarity and/or said apparatus terminals are temperature-controllable, in particular by means of a temperature-controlling fluid. To this end, these two current conducting devices of differing polarity and/or said apparatus terminals each have at least one fluid channel which serves the purpose of delivering the temperature-controlling fluid. Preferably, said fluid channels are connected to a heat exchanger. This preferred further development offers the advantage that the electrical heat output can be dissipated in said two current conducting devices of differing polarity and/or in said apparatus terminals during the in particular long-term supply of consumer loads or during charging of the battery module.

This preferred embodiment preferably comprises one of said voltage converters for the purpose of converting the voltage provided by the interconnected battery modules to suit the rated voltage required by the supplied consumer loads. The voltage converter is particularly preferably connected between the second electrical switching device and said electrical connection device. This voltage converter is preferably controllable by the monitor device when one of said battery module arrays has been isolated from the second electrical switching device.

Preferably, this preferred embodiment comprises one of said measuring devices, one of said extinguishing devices, one of said temperature control devices, one of said communication devices, one of said extraction devices and/or one of said auxiliary energy supply devices.

This preferred embodiment offers the advantage that the supply of the consumer load that is connected to the energy supply apparatus is thus improved when one of said battery module arrays is isolated from the second electrical switching device.

According to a first preferred further development, at least one or a plurality of said battery module arrays each have a first number and a second number of battery modules. This preferred further development offers the advantage that the supply by said battery modules can take place even when at least one of said battery modules is isolated from the remaining battery modules. This preferred further development offers the advantage that the supply by the battery modules can take place even when at least one of said battery modules has failed.

According to a second preferred further development, at least one or a plurality of said battery module arrays includes only battery modules of the first number and at least one or a plurality of further said battery module arrays includes only battery modules of the second number. Preferably the battery module arrays with only battery modules of the first number make available the first power L₁, and the battery module arrays with only battery modules of the second module make available the power ΔL. Particularly preferably, all battery module arrays have the same number of battery modules, such that an isolated battery module array comprising only battery modules of the first number can be replaced by a battery module array comprising only battery modules of the second number, and vice versa, without the output of the first power L₁ being impaired.

This preferred further development offers the advantage that the supply by said energy supply apparatus can take place even when at least one of said battery module arrays is isolated from the second electrical switching device, the electrical connection device or the remaining battery modules. This preferred further development offers the advantage that the supply by said energy supply apparatus can take place even when at least one of said battery module arrays has failed.

### Preferred Embodiments of the Energy Supply Apparatus

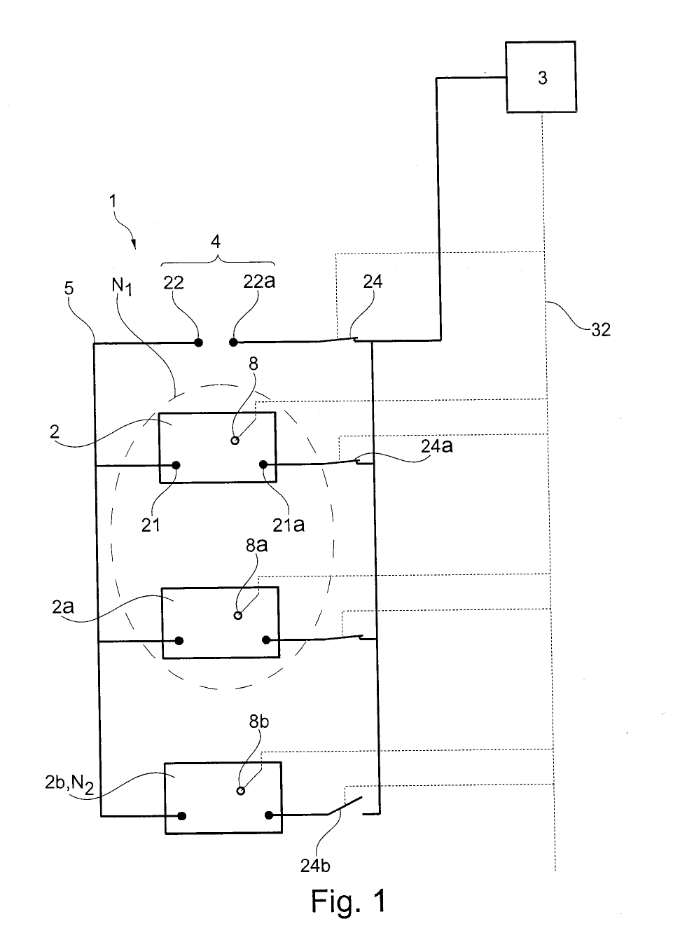

A first preferred embodiment of the energy supply apparatus (storage cabinet, FIGS. 1-7) includes at least:
a first number of said battery modules,
a second number of said battery modules,
one of said module accommodation devices,
one of said electrical switching devices,
said electrical connection device,
one of said measuring devices,
said monitor device,
said extinguishing device having an extinguishing agent store,
said temperature control device, preferably having a heat exchanger,
preferably one of said voltage converters,
preferably said auxiliary energy supply device,
preferably said communication device,
preferably one or a plurality of said bridging devices,
preferably said extraction device, preferably having said fluid cleaning device,
preferably one or more of said thermal protection devices.

The module accommodation device accommodates the following: the battery modules, said electrical switching device, said measuring device, said monitor device, said extinguishing device having an extinguishing agent store, said temperature control device, preferably said auxiliary energy supply device, preferably said communication device, preferably said bridging device, preferably said extraction device, preferably a plurality of said thermal protection devices, preferably one of said voltage converters. Preferably the module accommodation device is designed with a plurality of shelves for said battery modules, in particular with pull-out support surfaces, in particular as shelving or corresponding to a control cabinet.

The electrical switching device comprises at least two of said current conducting devices as well as at least one or a plurality of said switching elements. The battery modules are connected in series and/or in parallel by means of the electrical switching device. The interconnected battery modules are separably connected to the electrical connection device by means of the electrical switching device. Individual battery modules can be isolated, if required, from the remaining battery modules and/or from the electrical connection device by means of the switching elements.

According to a first preferred further development, the battery modules are connected in parallel by means of the electrical switching device. This preferred further development offers the advantage that a larger current can be drawn from the interconnected battery modules.

According to a second preferred further development, the battery modules are connected in series by means of the electrical switching device. This preferred further development offers the advantage that the interconnected battery modules can provide a larger voltage.

At least one, preferably two of said current conducting devices have said module terminal elements for the purpose of contacting said module terminals of individual battery modules. Preferably, said module terminal elements are designed for the quick changing of one of said battery modules.

The electrical connection device is accessible from the outside of the module accommodation device and is separably connected with the electrical switching device, in particular separably connected with its current conducting devices.

The voltage converter is preferably connected between the current conducting devices and the electrical connection device. One of said switching elements is connected between one of said current conducting devices and the voltage converter or between the voltage converter and the electrical connection device. The voltage converter is preferably designed both for converting a d.c. voltage into an a.c voltage and vice versa. The voltage converter is preferably designed for voltage amplification and/or attenuation.

The measuring device comprises at least one or a plurality of said measuring probes, preferably at least one measuring probe per battery module. Particularly preferably the measuring device comprises, for each battery module, at least one or a plurality measuring probes for the module voltage, module current, module temperature, an oxidation product and/or smoke. Furthermore, the measuring device comprises a probe switcher for interrogating the various measuring probes. Furthermore, the measuring device comprises measuring probe terminals to make contact with the various measuring probes. Preferably a plurality of said measuring probe terminals are collected at one of said multi-pole terminals.

The monitor device is signally connected with the measuring device. The monitor device is designed to monitor at least one of said physical parameters, in particular of the battery modules. The monitor device is designed to monitor measurement values which are provided by the measuring device. The monitor device is designed to relate at least one or a plurality of said measurement values with another of said measurement values, with a comparison value or with a comparison interval and to provide at least one result of a relation. The monitor device is designed to recognize whether a detected one of said physical parameters is outside a predefined range, preferably on the basis of the relating of the corresponding measurement value with a comparison value or a comparison interval. The monitor device is preferably designed to relate a plurality of said detected values to one another. The monitor device is preferably designed to reach a conclusion on the failure state of one of said battery modules, in particular dependent on at least one or a plurality of said measurement values or at least one of said results of a relation. The monitor device is designed to control or activate at least one of said switching elements, in particular to activate one of said switching elements, in particular when a detected one of said physical parameters is outside a predefined range.

Preferably, the monitor device is designed to activate at least one of said first switching elements for the purpose of isolating one of said battery modules from the associated first electrical switching device, in particular when a detected one of said physical parameters is outside a predefined range.

Preferably, the monitor device is designed to activate at least one or a plurality of said bridging devices, in particular when a detected one of said physical parameters is outside a predefined range, in particular when the battery module is isolated.

Preferably, a plurality of signal leads between the monitor device and further devices of the energy supply apparatus are configured as a signal bus. Said signal bus or said signal leads serve to transfer data, signals and/or measurement values between the monitor device, the measuring device, the communication device, the extinguishing device, the temperature control device, the extraction device, the bridging devices, and/or the switching elements of the electrical switching device.

Said signal leads or said signal bus are preferably accommodated by at least one signal conductor channel wherein said at least one signal conductor channel comprises a polymer and/or sheet metal.

The extinguishing device comprises an extinguishing agent store for an extinguishing agent and extinguishing agent channels. Said extinguishing agent channels connect the extinguishing agent store with at least one or a plurality of said battery, modules. Each of said extinguishing agent channels preferably comprises one of said controllable extinguishing agent valves.

According to a first preferred further development of this preferred embodiment, a plurality of extinguishing agent channels are guided from the extinguishing agent store to a plurality of, in particular all battery modules, in particular to their module housings. Thus delivery of the extinguishing agent can be targeted at one of the battery modules when said monitor device recognizes that said physical parameter, of which at least one is detected for each battery module, is outside a predefined range, in particular when the measuring device or one of the measuring probes detects an oxidation product and/or smoke. This preferred further development offers the advantage of increased operational safety of the energy supply apparatus.

According to a second preferred further development of this preferred embodiment, one of said extinguishing agent channels is guided from the extinguishing agent store successively through a plurality of, in particular all of said battery modules. Within a plurality of, preferably within all of said battery modules or their module housings, said extinguishing agent channel comprises at least one of said extinguishing agent vents. Preferably the extinguishing device comprises one of said controllable extinguishing agent valves for each extinguishing agent vent. The extinguishing agent valve is preferably controllable by the monitor device. This preferred further development offers the advantage that delivery of the extinguishing agent can be targeted at a compromised battery module. This further development offers the advantage that the pipework cost is reduced.

The temperature control device comprises:
at least one or a plurality of said temperature-controlling fluid channels leading to different battery modules, preferably one temperature-controlling fluid channel per battery module, preferably at least one central temperature-controlling fluid channel.
a plurality of said fluid channel segments which extend within the different battery modules, preferably at least one fluid channel segment per battery module, preferably with quick couplings for separating the particular fluid channel segment from the temperature-controlling fluid channel.
a temperature-controlling fluid which is conducted at least temporarily through at least one of said temperature-controlling fluid channels, and which serves the purpose of exchanging heat with at least one of said battery modules,
at least one controllable fluid conveying device for conveying the temperature-controlling fluid through at least one of said temperature-controlling fluid channels,
preferably at least one heat exchanger which is connected to at least one of said temperature-controlling fluid channels, and which has temperature-controlling fluid flowing through it, at least temporarily, and which is designed for the exchange of heat with the temperature-controlling fluid and/or with the surroundings,
preferably a plurality of said temperature-controlling-fluid vents which are preferably assigned to the individual battery modules, wherein particularly preferably at least one of said temperature-controlling-fluid vents opens up into one of said battery modules.

The heat exchanger of the temperature control device is preferably positioned adjacent to an outer wall of the module accommodation device, particularly preferably connected to said outer wall.

According to a first preferred further development of the temperature control device, a first central temperature-controlling fluid channel branches out after a controllable fluid conveying device into a plurality of temperature-controlling fluid channels, preferably as many temperature-controlling fluid channels as battery modules or fluid channel segments. After the fluid channel segments, the temperature-controlling fluid channels reunite to form a second central temperature-controlling fluid channel. The second central temperature-controlling fluid channel is connected to the heat exchanger. After the heat exchanger, the temperature-controlling fluid re-enters the first central temperature-controlling fluid channel. This preferred further development offers the advantage that the temperature-controlling fluid has essentially the same temperature at entry to the various fluid channel segments.

According to a second preferred further development, the first central temperature-controlling fluid channel comprises a plurality of successive fluid channel segments. The temperature-controlling fluid flows successively through said fluid channel segments of the different battery modules. After exiting the last of said fluid channel segments, the first central temperature-controlling fluid channel leads to the heat exchanger. After the heat exchanger, the temperature-controlling fluid re-enters the first central temperature-controlling fluid channel. This preferred further development offers the advantage that the cost of routing the temperature-controlling fluid is reduced.

Preferably, the energy supply apparatus comprises an auxiliary energy supply device. This auxiliary energy supply device is designed to receive energy at least temporarily from at least one of said battery modules. Said auxiliary energy supply device is designed to deliver energy at least temporarily to said monitor device, said measuring device and/or said extinguishing device, in particular when at least one of said battery modules fails, in particular when said monitor device recognizes that said physical parameter, of which at least one is detected for each battery module, is outside a predefined range, in particular when the supply voltage for the supply of the monitor device falls below a lower limit. Said auxiliary energy supply device is preferably designed to deliver energy at least temporarily to said communication device. This preferred embodiment offers the advantage that even after failure of at least one of said battery modules, essential functions can be performed by the monitor device.

The energy supply apparatus preferably comprises at least one or a plurality of said bridging devices. Said bridging device is connected either between the module terminals of one of said battery modules or between two of said module terminal elements. Preferably the bridging device can be controlled by the monitor device. This preferred embodiment offers the advantage that in the event of a failure of one of said battery modules, which is part of a series circuit of battery modules, the functionality of the series circuit can be restored.

Preferably, at least one of said bridging devices includes at least one of said discharge resistors. The monitor device is designed to discharge, at least temporarily, an in particular isolated battery module via said discharge resistor. Thus the charge state of the affected battery module can be reduced. This preferred embodiment offers the advantage of increased operational safety, in particular when the battery module is removed from the module accommodation device.

The energy supply apparatus preferably includes said extraction device. Said extraction device is connected with at least one or a plurality of said battery modules. The extraction device preferably comprises at least one of said extraction channels. The extraction device particularly preferably comprises a central extraction channel in which a plurality of extraction channel segments meet, wherein said extraction channel segments are connected with the various battery modules. Said extraction device preferably comprises a fluid conveying device for a fluid which is to be extracted, particularly preferably a pump. The extraction device preferably comprises a fluid cleaning device which preferably cleans the extracted fluid before the fluid's entry into the fluid conveying device. Said fluid cleaning device is designed to clean the extracted fluid before said extracted fluid exits into the environment. To this end the fluid cleaning device comprises a filter and/or air cleaner. This preferred embodiment offers the advantage that materials that exit through the pressure relief devices can be removed in a controlled manner.

Preferably, at least one of said thermal protection devices is positioned between at least two adjacent said battery modules within the module accommodation device. One each of said thermal protection devices is particularly preferably arranged between at least two said adjacent battery modules.

The battery modules of said first preferred embodiment each have one of said module housings. The module housings each comprise a module box and a module lid.

The module housings, in particular its module boxes have:
two of said module terminals of differing polarity which are connected to one of said walls of the module box and is preferably guided through said wall of the module box,
at least one of said measuring probe terminals in one of said walls of the module box, preferably one of said multi-pole terminals,
preferably at least two access points to one of said fluid channel segments, configured in particular as quick couplings, said access points being positioned in said walls of the module box,
preferably at least one of said extinguishing agent vents, positioned in one of said walls of the module box,
preferably one of said pressure relief devices positioned in one of the walls of the module box.

Within each module housing, in particular within each of the module boxes are arranged:
two or more of said electrochemical cells which are connected with one another, preferably in series,
one or a plurality of said measuring probes which is connected with one of said measuring probe terminals, wherein at least one of said measuring probes is configured for the detection of an oxidation product and/or smoke, wherein at least one of said measuring probes is configured for the measuring of the module current, wherein at least one of said measuring probes is configured for the measuring of the module voltage,
at least one of said probe switchers, in particular for interrogating the measuring probes in succession,
one or a plurality of said fluid channel segments which is accessible by means of at least one access point, preferably through one, particularly preferably through two of said quick couplings in at least one of said walls of the module box,
preferably one of said discharge resistors through which the cells of the battery module can be discharged when the battery module is in the isolated state, wherein said discharge resistor is thermally conductively connected with the module box and/or with one of said fluid channel segments,
preferably said cell connection device for connecting the cells together, preferably for connecting the cells in series, and which is connected with the module terminals,
preferably one of said switching elements which is particularly preferably connected between one of said module terminals and the cell connection device, wherein said switching element serves in particular the purpose of isolating the battery module,

This preferred embodiment offers the advantage that the supply of at least one consumer load can be maintained in the event of a failure of one of the battery modules, in particular without human intervention.

A second preferred embodiment of the energy supply apparatus differs from the first preferred embodiment in particular in that parts of the extinguishing device are integrally formed with parts of the temperature control device, at least in sections.

According to a first preferred further development of this preferred embodiment, at least some of the extinguishing agent channels are integrally formed with several of said temperature-controlling fluid channels, at least in sections. Thus the extinguishing agent also serves as temperature-controlling fluid. After a controllable fluid conveying device, a first central temperature-controlling fluid channel branches out into a plurality of temperature-controlling fluid channels, preferably as many temperature-controlling fluid channels as battery modules or fluid channel segments. After the fluid channel segments, at least some of said temperature-controlling fluid channels rejoin to form a second central temperature-controlling fluid channel. The second central temperature-controlling fluid channel is connected with the heat exchanger. After the heat exchanger, the temperature-controlling fluid re-enters the first central temperature-controlling fluid channel. Said temperature-controlling fluid channels each have at least one of said fluid channel segments within the module housings. Said fluid channel segments each have one temperature-controlling-fluid vent within the module housing. Said temperature-controlling-fluid vents are each provided with a controllable valve. Thus the temperature-controlling-fluid vents and said extinguishing agent vents are integrally formed. This preferred further development offers the advantage that the equipment costs for temperature control and extinguishing are reduced. This further development offers the advantage that a uniform temperature control of the battery module is simplified by having the temperature-controlling fluid of extinguishing agent reach the battery modules with essentially the same temperature.

According to a second preferred further development of this preferred embodiment, said extinguishing agent channel is integrally formed with one of said temperature-controlling fluid channels, at least in sections. Thus the extinguishing agent serves also as temperature-controlling fluid. Each said temperature-controlling fluid channel has at least one or a plurality of said fluid channel segments within the module housings. Said fluid channel segments each have at least one of said temperature-controlling-fluid vents within the module housings. Said temperature-controlling-fluid vents are each provided with a controllable valve. Thus the temperature-controlling-fluid vents and said extinguishing agent vents are integrally formed, at least in sections. The first central temperature-controlling fluid channel joins with one of said fluid channel segments. The temperature-controlling fluid flows through a plurality of said fluid channel segments of the various battery modules, preferably in succession. After exiting the last of said fluid channel segments, the second central temperature-controlling fluid channel leads to the heat exchanger. After the heat exchanger, the temperature-controlling fluid re-enters the first central temperature-controlling fluid channel. This preferred further development offers the advantage that the cost of routing the temperature-controlling fluid or the extinguishing agent is reduced. This preferred further development offers the advantage that the delivery of extinguishing agent can be targeted at a compromised battery module. This preferred further development offers the advantage that the equipment costs for temperature control and extinguishing are reduced.

A third preferred embodiment of the energy supply apparatus comprises at least:
two or more of said module accommodation devices,
a first number of said battery modules for each module accommodation device,
a second number of said battery modules for each module accommodation device,
a first of said electrical switching devices for each module accommodation device,
a second of said electrical switching devices,
one of said electrical connection devices,
one of said measuring devices,
one of said monitor devices,
one of said extinguishing devices with an extinguishing agent store,
one of said temperature control devices, preferably with a heat exchanger,
preferably one of said voltage converters,
preferably said auxiliary energy supply device,
preferably one of said communication devices,
preferably one of said extraction devices,
preferably a plurality of said thermal protection devices,
preferably one of said module exchange devices,
preferably one of said module containers.

The individual battery modules are configured according to a first preferred embodiment of the energy supply apparatus.

Each of said module accommodation devices accommodates a plurality of said battery modules and a first of said electrical switching devices. The first electrical switching device and said battery module preferably forms one of said battery module arrays. Each of said module accommodation devices preferably accommodates at least one or a plurality of said thermal protection devices which are each particularly preferably arranged between two of said battery modules.

Preferably at least one or a plurality of said module accommodation devices are configured as a rack with shelves positioned in particular one above the other, particularly preferably with pull-out support surfaces. The module accommodation device preferably accommodates at least one or a plurality of said bridging devices, particularly preferably one of said bridging devices for each of the battery modules. Preferably, said first electrical switching device is accessible or contactable from the outside of the module accommodation device, at least in sections.

Within each of said module accommodation devices, said battery modules are connected with one another at least temporarily through said first electrical switching device, in particular in series.

Said first electrical switching devices each comprise at least one, two or more of said current conducting devices. Said first electrical switching devices each comprise at least one or a plurality of said switching elements, called first switching elements in the following. The current conducting devices each comprise at least one, two or more of said module terminal elements.

According to a first preferred further development, the battery modules in at least one or a plurality of, preferably all of said module accommodation devices are connected in series by means of the first electrical switching device. One each of said bridging devices is preferably connected between the module terminals of differing polarity of each of said battery modules of the series circuit. The monitor device is designed to activate said bridging devices, in particular to control their closure, in particular when it is recognized that said physical parameter, of which at least one is detected for each battery module, is outside a predefined range. When the bridging device is activated, the associated battery module is bridged and the series circuit of the remaining of said battery modules is re-established. This preferred further development offers the advantage that the total voltage of the interconnected battery modules is enlarged.

According to a second preferred further development, the battery modules in at least one or a plurality of, preferably all of said module accommodation devices are connected in parallel by the first electrical switching device. Said first electrical switching device preferably comprises one of said first switching elements for each connected battery module. Said first switching element is connected between the corresponding battery module and one of the current conducting devices of the first electrical switching device. Said first switching element serves to isolate the connected battery modules. The monitor device is designed to activate the first switching element, in particular to control its opening, in particular when it is recognized that said physical parameter, of which at least one is detected for each battery module, is outside a predefined range. This preferred further development offers the advantage that the interconnected battery modules can deliver a stronger current.

In the following, an arrangement with said first electrical switching device, said first number of battery modules and said second number of battery modules is also called battery module array. In said battery module array, the battery modules are connected with one another in series and/or in parallel by the first electrical switching device.

Said second electrical switching device is designed to connect, at least temporarily, a plurality of said first electrical switching devices, or their connected battery modules, with one another. The second electrical switching device is designed to isolate a group of battery modules which are connected to one another by means of one of said first electrical switching devices, in particular when the monitor device recognizes that said physical parameter, of which at least one is detected for each battery module, is outside a predefined range, in particular when at least one of the battery modules of said group of battery modules has failed, in particular when one of said measuring probes has detected an oxidation product and/or smoke. The first electrical switching devices and with it the battery modules of said plurality of module accommodation devices are in particular connected in parallel with one another by means of said second electrical switching devices. The battery modules of said plurality of module accommodation devices are separably connected with the electrical connection device by means of said second electrical switching device. Said second electrical switching device comprises at least one, two or more of said current conducting devices. The second electrical switching device comprises at least one or a plurality of said switching elements, in the following called second switching elements. The current conducting devices each have at least one or a plurality of said module terminal elements.

The first electrical switching devices, and with them the battery modules which are electrically connected with said electrical switching device, are each separably connected with the second electrical switching device by means of one of said second switching elements. Said second switching element is provided to be activated by the monitor device, in particular when said monitor device recognizes that said physical parameter, of which at least one is detected for each battery module, is outside a predefined range. In the open state of one of said second switching elements, essentially all battery modules, which are electrically connected with the associated first electrical switching device, are isolated from said second electrical switching device.

The measuring device comprises at least one or a plurality of said measuring probes, preferably at least one measuring probe per battery module. The measuring device particularly preferably comprises, for each battery module, at least one or a plurality of measuring probes for the module voltage, module current, module temperature, an oxidation product and/or smoke. Furthermore, the measuring device comprises one of said probe switchers for interrogating the various measuring probes. Furthermore, the measuring device comprises measuring probe terminals to make contact with the various measuring probes. Preferably a plurality of measuring probe terminals for the measuring probes of one of said battery modules are collected at one multi-pole terminal.

The monitor device is signally connected with the measuring device. The monitor device is designed to monitor physical parameters, in particular physical parameters of the battery modules. The monitor device is designed to monitor measurement values which are provided by the measuring device. The monitor device is designed to relate at least one or a plurality of said measurement values with another of said measurement values, with a comparison value or with a comparison interval, and to provide at least one result of a relation. The monitor device is designed to recognize whether a detected one of said physical parameters is outside a predefined range, preferably subsequent to the relating of the corresponding measurement value with a comparison value or a comparison interval. The monitor device is preferably designed to relate a plurality of said detected measurement values with one another. The monitor device is preferably designed to reach a conclusion on the failure state of one of said battery modules, in particular dependent on at least one or a plurality of said measurement values or one of said results of a relation. The monitor device is designed to control or activate at least one of said switching elements, in particular when a detected one of said physical parameters is outside a predefined range. The monitor device is preferably designed to activate at least one or a plurality of said bridging devices, in particular when a detected one of said physical parameters is outside a predefined range.

Preferably, the monitor device is designed to activate at least one of said first switching elements for the purpose of isolating one of said battery modules from the associated first electrical switching device, in particular when a detected one of said physical parameters is outside a predefined range.

Preferably, the monitor device is designed to activate one or more of said bridging devices, in particular when a detected one of said physical parameters is outside a predefined range, in particular when the battery module is isolated.

Preferably, the monitor device is designed to trigger the isolating of a group of battery modules which have been connected to one another by a first of said electrical switching devices. To this end, the monitor device can transmit an appropriate signal to said second electrical switching device or to one of its second switching elements.

Preferably, the monitor device is designed to connect one of said first electrical switching devices to said second electrical switching device, in particular subsequent to the isolating of a group of battery modules. To this end, each monitor device of said first electrical switching device or one of its switching elements can transmit an appropriate signal.

A plurality of signal leads between the monitor device and further devices of the energy supply apparatus are preferably designed as a signal bus. Said signal bus or said signal leads serve to transfer data, signals and/or measurement values between the monitor device, the measuring device, the communication device, the extinguishing device, the temperature control device, the extraction device, the bridging devices, and/or the switching elements of the electrical switching device. Said signal leads or said signal bus are/is preferably accommodated by at least one signal conductor channel, wherein said at least one signal conductor channel comprises a polymer and/or a sheet metal. The extinguishing device comprises an extinguishing agent store for an extinguishing agent and extinguishing agent channels. Said extinguishing agent channels connect the extinguishing agent store with at least one or a plurality of said battery modules. Each of said extinguishing agent channels preferably comprises one of said controllable extinguishing agent valves.

According to a first preferred further development of this preferred embodiment, a plurality of extinguishing agent channels are guided from the extinguishing agent store to all of the battery modules, in 3ar to their module housings. Thus the delivery of extinguishing agent can be targeted at one of the battery modules, when said monitor device recognizes that said physical parameter, of which at least one is detected for each battery module, is outside a predefined range, in particular when the measuring device or one of the measuring probes detects an oxidation product and/or smoke. This preferred further development offers the advantage of increased operational safety of the energy supply apparatus.

According to a second preferred further development of this preferred embodiment, one of said extinguishing agent channels is lead from the extinguishing agent store and successively through a plurality of said battery modules. Within most, preferably within each of said battery modules or their module housings, said extinguishing agent channel each comprises at least one of said extinguishing agent vents. Preferably the extinguishing device comprises one controllable extinguishing agent valve for each extinguishing agent channel. The extinguishing agent valve is preferably controllable by the monitor device. This preferred further development offers the advantage that the delivery of extinguishing agent can be targeted at a compromised battery module. This further development offers the advantage that the pipework cost is reduced.

The temperature control device comprises:
a plurality of said temperature-controlling fluid channels leading to various battery modules, preferably one temperature-controlling fluid channel per battery module, preferably at least one central temperature-controlling fluid channel,
a plurality of said fluid channel segments which are assigned to various battery modules, preferably at least one fluid channel segment per battery module, preferably with quick couplings for separating the particular fluid channel segments from the temperature control device,
a temperature-controlling fluid which is conducted, at least temporarily, through said temperature-controlling fluid channels,
at least one controllable fluid conveying device for conveying temperature-controlling fluid through at least one of said temperature-controlling fluid channels,
preferably at least one heat exchanger which is connected to at least one of said temperature-controlling fluid channels, and which has temperature-controlling fluid flowing through it at least temporarily, and which is designed for exchanging heat with the temperature-controlling fluid and/or with the surroundings.
preferably a plurality of said temperature-controlling-fluid vents which are preferably assigned to the various battery modules, wherein particularly preferably at least one of said temperature-controlling-fluid vents is positioned in one of said battery modules.

The heat exchanger of the temperature control device is preferably adjacent to an outer wall of the module accommodation device, particularly preferably connected to said outer wall.

According to a first preferred further development of the temperature control device, a first central temperature-controlling fluid channel branches out after a controllable fluid conveying device into a plurality of temperature-controlling fluid channels, preferably as many temperature-controlling fluid channels as battery modules or fluid channel segments. After the fluid channel segments, the temperature-controlling fluid channels reunite to form a further central temperature-controlling fluid channel. The second central temperature-controlling fluid channel is connected to the heat exchanger. After the heat exchanger, the temperature-controlling fluid re-enters the first central temperature-controlling fluid channel. This preferred further development offers the advantage that the temperature-controlling fluid has essentially the same temperature at entry to the various fluid channel segments.

According to a second preferred further development, the first central temperature-controlling fluid channel joins one of said fluid channel segments. The temperature-controlling fluid flows in particular successively through a plurality of said fluid channel segments of the various battery modules. After exiting the last of said fluid channel segments, the second central temperature-controlling fluid channel leads to the heat exchanger. After the heat exchanger, the temperature-controlling fluid re-enters the first central temperature-controlling fluid channel. This preferred further development offers the advantage that the cost of routing the temperature-controlling fluid is reduced.

Said voltage converter is preferably connected between the current conducting devices and the electrical connection device. One of said second switching devices is connected between one of said current conducting devices and the voltage converter or between the voltage converter and the electrical connection device. The voltage converter is designed for converting a d.c. voltage into an a.c. voltage and vice versa. The voltage converter is preferably designed for voltage amplification or attenuation.

The energy supply apparatus preferably comprises an auxiliary energy supply device. Said auxiliary energy supply device is designed to receive energy at least temporarily from at least one of said battery modules. Said auxiliary energy supply device is designed to deliver energy, at least temporarily, to said monitor device, said measuring device, and/or said extinguishing device, in particular when at least one of said battery modules fails, in particular when said monitor device recognizes that said physical parameter, of which at least one is detected for each battery module, is outside a predefined range. Said auxiliary energy supply device is preferably designed to deliver energy at least temporarily to said communication device. This preferred embodiment offers the advantage that even after failure of at least one of said battery modules, essential functions can be performed by the monitor device.

The energy supply apparatus preferably comprises at least one or a plurality of said bridging devices. Said bridging device is connected either between the module terminals of one of said battery modules or between two of said module terminal elements. Preferably the bridging device can be controlled by the monitor device. This preferred embodiment offers the advantage that in the event of failure of one of said battery modules, which is part of a series circuit of battery modules, the series circuit can be restored.

Preferably, at least one of said bridging devices includes one of said discharge resistors. The monitor device is designed to discharge at least temporarily an in particular isolated battery module via the discharge resistor. Thus the charge state, i.e. the stored energy, of the affected battery module, is reduced, in particular before the removal of the particularly isolated battery module from the energy supply apparatus. This preferred embodiment offers the advantage of increased operational safety.

The energy supply apparatus preferably includes said extraction device. Said extraction device is connected with at least one or a plurality of said battery modules. The extraction device preferably comprises, in particular for each module accommodation device, at least one of said extraction channels. The extraction device preferably comprises at least one central extraction channel in which a plurality of said extraction channel segments meet. Said extraction channel segments are connected with the various battery modules particularly of the same module accommodation device. Said extraction device preferably comprises a fluid conveying device for a fluid which is to be extracted, particularly preferably a pump. The extraction device preferably comprises a fluid cleaning device which preferably cleans the extracted fluid before the fluid's entry into the fluid conveying device. Said fluid cleaning device is designed to clean the extracted fluid, before said extracted fluid exits into the environment. To this end, the fluid cleaning device comprises a filter and/or air cleaner. This preferred embodiment offers the advantage that materials that exit via the pressure relief devices can be removed in a controlled manner.

According to a preferred further development, the extraction device includes, for each module accommodation device, an arrangement of one first central extraction channel as well as at least one extraction channel segment for each battery module of the module accommodation device, wherein said extraction channel segments join said first central extraction channel. A plurality of said first central extraction channels joins a second central extraction channel. Said second central extraction channel joins said fluid cleaning device. The fluid conveying device of the extraction device is preferably part of the second central extraction channel. Each one of said first central extraction channels preferably includes one of said measuring probes, in particular for detecting an oxidation product and/or smoke. This further development offers the advantage of a channeled delivery of a extracted fluid to said fluid cleaning device. This further development offers the advantage that a determination of a failed battery module is simplified.

The energy supply apparatus preferably includes one of said module exchange devices. Said module exchange device is designed to remove an in particular failed battery module in particular from one shelf of one of said module accommodation devices. Said module exchange device is designed to deliver one of said battery modules to one of said module accommodation devices, in particular to install it in a shelf of one of said module accommodation devices. Said module exchange device is preferably signally connected with said monitor device.

Said module exchange device preferably includes a grab which is designed to releasably pick up one of said battery modules at least temporarily. The module exchange device preferably includes a grab-guiding device for directing and moving the grab relative to the remaining battery modules or the module accommodation devices.

The module exchange device is designed:
to receive a signal from the monitor device, wherein an identifier for the battery module to be picked up, of one of said module accommodation devices or for the associated shelf is added to the signal.
to collect the battery module corresponding to the identifier, in the following called the first battery module, and to remove it from the module accommodation device,
to store the first battery module in an examination area, wherein preferably said examination area is designed to examine the first battery module,
to store the first battery module in one of said module containers,
to accommodate a second of said battery modules which does not yet belong to said energy supply apparatus, and which is not yet connected with said energy supply apparatus,
to deliver in particular the second battery module to a shelf of one of said module accommodation devices, in particular to the shelf corresponding to the identifier,
to install the second battery module onto one of said shelves, in particular onto the shelf corresponding to the identifier,
upon installation of the second battery module, to preferably install its module terminals in corresponding module terminal elements, in particular to prepare a contacting of the second battery module, in particular to achieve said contacting,
upon installation of the second battery module, to preferably contact its measuring probe(s), in particular to connect its measuring probe terminals with corresponding signal leads,
upon installation of the second battery module, to preferably connect its quick couplings with at least one of said extinguishing agent channels and/or with one of said temperature-controlling fluid channels.
upon installation of the second battery module, to preferably prepare its connection with at least one of said signal leads, in particular to achieve said connection.

Said module exchange device offers the advantage that a first battery module can be removed and a second battery module can be installed without human assistance.

The plurality of module accommodation devices are preferably positioned adjacent to one another, in particular as a rack. The shelves preferably include an pull-out support surface which serves to simplify the removal of the battery module accommodated by the shelf, and which also serves to simplify the installation onto the shelf of the battery module collected by the grab. Both the module accommodation devices and the second of said electrical switching devices are preferably enclosed by an apparatus container, in particular a container or shipping container. The electrical connection device is preferably accessible or contactable from the outside of said apparatus container. The electrical connection device is preferably designed according to a storage-and-retrieval unit. The grab of the storage-and-retrieval unit is particularly preferably driven in particular while hanging from at least one rail. The heat exchanger of the temperature control device is preferably positioned outside the apparatus container. Preferably the communication device, in particular a data interface, an antenna, a means of illumination and/or a loudspeaker of the communication device are guided out of the apparatus container or are accessible from the surroundings of the apparatus container. Preferably the examination area is arranged for the storage of a failed battery module in said apparatus container.

This preferred embodiment offers the advantage that in the event of a failure of one of the battery modules, the supply of at least one consumer load can be maintained in particular without human intervention.

A fourth preferred embodiment differs from the third preferred embodiment in particular in that parts of the extinguishing device and parts of the temperature control device are integrally formed, at least in sections. Thus the temperature-controlling fluid also serves as extinguishing agent. Preferably at least one of said temperature-controlling fluid channels is integrally formed, at least in sections, with at least one of said extinguishing agent channels between one fluid conveying device of the temperature control device and at least one of said module housings. Preferably a plurality of said temperature-controlling fluid channels branch out from a central temperature-controlling fluid channel to the various battery modules or module housings.

This preferred embodiment offers the advantage that the supply of at least one of the consumer loads in the event of failure of one of the battery modules can be maintained in particular without human intervention. This preferred embodiment offers the advantage that the equipment costs for routing the extinguishing agent are reduced. This preferred embodiment offers the advantage that the extinguishing agent can be configured as a simple additive to the temperature-controlling fluid.

### Operating Method

A method for the operation of one of said energy supply apparatuses, according to the invention, or according to a preferred further development or embodiment includes at least one of the following steps:
S1 measuring one of said physical parameters, in particular a physical parameter concerning one of said battery modules, by means of said measuring device, in particular by means of at least one of its measuring probes,
S2 providing of one of said measurement values by one of said measuring devices, preferably to the monitor device, particularly after S1,
S3 evaluating or processing of at least one of said measurement values by the monitor device, preferably relating said measurement value with a comparison value, particularly preferably with one of said predefined ranges, particularly after S2, wherein the monitor device can process in particular a result of a relation or a logical value, wherein the monitor device can give at least one order,
S4 Isolating at least one of said battery modules from the remaining battery modules by means of one of said electrical switching devices, preferably by opening one of said switching elements of said electrical switching device, in particular triggered by the monitor device, in particular after S3, in particular when at least two of said battery modules are connected in parallel, in particular when said monitor device recognizes that said physical parameter, of which at least one is detected for each battery module, is outside one of said predefined ranges,
S5 Bridging an isolated one of said battery modules with one of said bridging devices, in particular triggered by the monitor device, in particular after S3, in particular when at least two of said battery modules are connected in series, in particular when said monitor device recognizes that said physical parameter, of which at least one is detected for each battery module, is outside one of said predefined ranges,
S6 activating of the temperature extinguishing device, in particular by the monitor device, in particular after S3, preferably when said monitor device recognizes that said physical parameter, of which at least one is detected for each battery module, is outside one of said predefined ranges, further preferably when a detected temperature of one of said battery modules lies outside a permitted operating temperature range, further preferably when an oxidation product and/or smoke is detected, whereupon the extinguishing agent is delivered to at least one of the battery modules,
S7 activating of the temperature control device, in particular by the monitor device, in particular after S3, preferably when said monitor device recognizes that said physical parameter, of which at least one is detected for each battery module, is outside one of said predefined ranges, further preferably when a detected temperature of one of said battery modules lies outside a permitted operating temperature range, whereupon heat is exchanged with at least one of said battery modules,
S8 activating of the communication device, in particular by the monitor device, in particular after S3, in particular when said monitor device recognizes that said physical parameter, of which at least one is detected for each battery module, is outside one of said predefined ranges, whereupon at least one of said physical parameters or a result of a relation is communicated,
S9 removing of one of said battery modules from the energy supply apparatus, in particular from said module accommodation device, in particular after S3, in particular after S4, in particular after S8, in particular by the module exchange device, wherein in particular said module terminals and/or said quick couplings are disconnected,
S10 installing of one of said battery modules in said module accommodation device, in particular after S8, in particular after S9, in particular by the module exchange device, wherein in particular said module terminals and/or said quick couplings are connected,
S11 activating of one of said battery modules, in particular by the monitor device, in particular after S4, in particular after S10,
S12 suitable converting of the voltage provided by the interconnected battery modules, in particular by said voltage converter, preferably a converting of a provided d.c. voltage to an a.c. voltage, further preferably a decreasing of the provided d.c. voltage, particularly preferably a decreasing of the provided d.c. voltage to an a.c. voltage, for the supply of operated consumer loads by means of an a.c. voltage,
preferably:
S15 isolating of at least one of said battery module arrays from the remaining battery module arrays by means of one of said switching elements of the second electrical switching device, in particular triggered by the monitor device, in particular after S3, in particular when said monitor device recognizes that said physical parameter, of which at least one is detected for each battery module, is outside one of said predefined ranges,
S16 connecting of one of said battery module arrays with the second electrical switching device by means of one of said switching elements of the second electrical switching device, in particular by the monitor device, in particular after S15.

### Preferred Embodiment of the Operating Method

For a first preferred operating method (“Operating Method 1”), at first only the battery modules of the first number are connected to one another by means of the electrical switching device and connected to the electrical switching device itself. The battery modules of the second number are isolated from the electrical switching device as well as from the battery modules of the first number by means of the electrical switching device. The monitor device, and preferably also said measuring device, is/are supplied with energy from at least one of said battery modules of the first number. Said auxiliary energy supply device is preferably connected between the monitor device and said battery modules. Preferably said particularly bidirectional voltage converter is connected between the electrical switching device and the electrical connection device, in particular for the purpose of converting a d.c. voltage provided by the interconnected battery modules into an a.c. voltage at the electrical connection device for the at least one consumer load that is to be supplied.

One of said physical parameters is detected according to Step S1, in particular periodically, preferably by said measuring device, particularly preferably by one of its measuring probes. Preferably, the electrical voltage of the interconnected battery modules of the first number, the strength of the electrical current which is drawn from said interconnected battery modules of the first number, and/or the temperature of at least one of said interconnected battery modules is/are detected.

The measuring device, according to Step S2, makes at least one of said measurement values available to the monitor device. The measuring device preferably makes available to the monitor device one particular measurement value each relating to module voltage, module current and/or module temperature, in particular periodically.

The monitor device evaluates the measurement value according to Step S3, preferably by relating said measurement value with a comparison value and/or with one of said predefined ranges. The monitor device preferably processes at least one of said measurement values into a logical value which gives information about the operating state of the associated battery module. The monitor device decides between the supply state and the failure state of one of said battery modules, based on at least one of said physical parameters, one of said associated measurement values or said logical value.

When, based on Step S3, only an increased temperature of the associated battery module, preferably higher than 60° C., further preferably higher than 40° C., is to be assumed, then the temperature control device, preferably its fluid conveying device, is activated for the purpose of removing heat from said battery module, according to Step S7, in particular by the monitor device. The communication device is preferably activated, according to Step S8, for the purpose of communication of the triggered corrective action.

The monitor device assumes the failure state of one of said battery modules, in particular when, according to the evaluation of Step S3:
said physical parameter, of which at least one is detected for each battery module, is outside a predefined range,
a minimum voltage, in particular a minimum terminal voltage can no longer be provided by said battery module,
a minimum current can no longer be delivered by the battery module,
The charge state does not lie within a permitted charge state range, and/or
the module temperature lies outside a permitted operating temperature range, wherein the permitted operating temperature range is preferably delimited by T₁ and T₂.

When a failure state is present, the monitor device can initiate at least one from a plurality of corrective actions, as described in the following. The communication device is thus preferably activated, according to Step S8, in particular for communicating the taken corrective action

The measuring of physical parameters according to Step S1 is preferably also continued during and after taking a corrective action. This preferred embodiment offers the advantage of increased safety of the energy supply apparatus.

As a first corrective action, the battery module can be isolated, according to Step S4, from the remaining battery modules as well as from the electrical connection device, by means of said electrical switching device, in particular by means of said electrical switching device being triggered by the monitor device. Said first corrective action is preferably taken when the failure state is not associated with a serious threat to the surroundings from the battery module, particularly preferably in the event of advanced ageing of the battery module. To this end the monitor device preferably controls one of the switching elements of the electrical switching device. When the battery module to be isolated is part of a series circuit of a plurality of said battery modules, then the battery module to be isolated is preferably bridged by means of one of said bridging devices, according to step S5, in particular triggered by the monitor device. One of said battery modules, further preferably a battery module of the second number, further preferably a previously isolated battery module, is preferably connected, after Step S4, to the electrical connection device by means of the electrical switching device, according to Step 11. The monitor device preferably controls one of the switching elements of the electrical switching device for Step S11. The communication device is preferably activated, according to Step S8, for the purpose of communicating the initiated corrective action.

As a preferred further development of said first corrective action, the isolated battery module is removed from the energy supply apparatus after Step S4 or Step S5, according to Step S9. The battery module is preferably placed in said examination area for the purpose of examining the battery module. The battery module is preferably introduced to said module container, in particular depending on the result of the examination of the battery module in the examination area. One of said battery modules is preferably installed in the place of the removed battery module, according to Step S10. The newly installed battery module is preferably activated after installation according to Step S11. This preferred further development offers the advantage that the failed battery module cannot adversely affect the remaining battery modules of the energy supply apparatus. This preferred further development offers the advantage that the failed battery module lies ready for examination in the examination area, in particular without human interaction.

When, based on Step S3, a fire or an imminent fire of one of said battery modules is assumed, the monitor device can take a second corrective action. To this end, the extinguishing device is activated in order to deliver the extinguishing agent to said battery module, according to Step S6, in particular by the monitor device. The communication device is preferably activated, according to Step S8, for the purpose of communicating the initiated corrective action. The monitor device in particular initiates said second corrective action when, due to at least one of said physical parameters, the effect of the first corrective action does not appear to be sufficient. The monitor device preferably initiates said second corrective action when the failure state is associated with a threat to the surroundings, in particular in the case of increased temperature of the battery module or presence of an oxidation product and/or smoke. Said corrective action can advantageously be combined with the first corrective action.

As a preferred further development of said second corrective action, the battery module of the energy supply apparatus is removed, according to Step S9. Preferably the battery module is placed in said examination area for the purpose of investigating the battery module. The battery module is preferably introduced to said module container, in particular depending on the result of the examination of the battery module in the examination area. One of said battery modules is preferably installed in the place of the removed battery module, according to Step S10. The newly installed battery module is preferably activated after installation, according to Step S11. This preferred further development offers the advantage that the failed battery module cannot adversely affect the remaining battery modules of the energy supply apparatus. This preferred further development offers the advantage that the failed battery module lies ready for examination in the examination area, in particular without human interaction.

This preferred embodiment offers the advantage that the at least one consumer load can be supplied with the first power L₁. This preferred embodiment offers the advantage that corrective actions, in particular according to Step S6 and/or S9 can be taken in particular without human interaction, whereby the operational safety of the energy supply apparatus is increased.

For a second preferred operating method (“Operating Method 2”), essentially all of said battery modules of the energy supply apparatus are first connected with one another by means of the electrical switching device and connected with the electrical connection device. The monitor device, preferably also said measuring device, is supplied with energy from at least one of said battery modules of the first number. Said auxiliary energy supply device is preferably connected between the monitor device and said battery modules. Said in particular bidirectional voltage converter is preferably connected between the electrical switching device and the electrical connection device, further preferably for the purpose of converting a d.c. voltage provided by the interconnected battery modules into an a.c. voltage at the electrical connection device for the at least one consumer load which is to be supplied, further preferably for the reduction of the total voltage of the interconnected battery modules, in particular to suit the voltage required by the consumer loads.

In the following, the differences from Operating Method 1 are described.

When, following Step S3, a failure state is assumed as previously described, Step S12 is executed in a temporal relationship with, preferably essentially simultaneously with, one of the Steps S4, S5 and/or S6. Thus the voltage provided by the interconnected battery modules is converted to suit the voltage required by the supplied consumer loads by means of the voltage converter, preferably increased to the voltage required by the supplied consumer loads.

This preferred embodiment offers the advantage that the at least one consumer load can be supplied with the first power L₁. This preferred embodiment offers the advantage that corrective actions, in particular according to Step S6 and/or Step S9, can be taken essentially without human interaction whereby the operational safety of the energy supply apparatus is increased.

For a third preferred operating method (“Operating Method 3”), the energy supply apparatus comprises a plurality of said battery module arrays and is preferably designed according to the third preferred embodiment. Their first electrical switching devices each connect a plurality of said battery modules, in particular in series. Said first electrical switching devices are connected to one another by means of a second electrical switching device. The second electrical switching device is connected with the electrical connection device, in particular by means of one of said voltage converters.

In the following, the differences from Operating Method 2 are described.

When, directly following Step S3, a failure state of one or a plurality of battery modules or even at least one of said battery module arrays is assumed, then the associated battery module array or its first electrical switching device is isolated from the second electrical switching device, according to Step S15, in particular by means of a second of said switching elements, in particular triggered by said monitor device. Step S15 preferably takes place when a plurality of battery modules of the same battery module array have simultaneously assumed the failure state, particularly preferably when an exceeded upper temperature limit, an oxidation product and/or smoke has been detected for a plurality of said battery modules. Step S12 is preferably executed in a temporal relationship with, particularly preferably essentially simultaneously with Step S15, particularly preferably when, as a consequence of Step S15, the electrical voltage supplied by the battery modules is lower than the voltage required by the supplied consumer loads. Thus the voltage supplied by the interconnected battery module arrays is converted by the voltage converter to suit the voltage required by the supplied consumer loads, preferably increased to the voltage required by the supplied consumer loads.

Preferably, a further one of said battery module arrays or its first electrical switching device is connected with the second electrical switching device according to Step S16, in particular after Step S15.

The extraction device and/or the fluid cleaning device is preferably activated essentially simultaneously with Step S6, in particular by means of one of said thermostats. At least one of said extinguishing agent vents and/or at least one of said temperature-controlling-fluid vents is preferably opened essentially simultaneously with Step S6, whereupon extinguishing agent and/or temperature-controlling fluid can be delivered to at least one of said battery modules in the failure state. This preferred embodiment offers the advantage that the operational safety of the energy supply apparatus is increased.

A battery module removed according to Step S9 is preferably transferred to the module container. There the reaction in the removed battery module can decay without the surroundings being impaired more than necessary. This preferred embodiment offers the advantage that the operational safety of the energy supply apparatus is increased.

This preferred embodiment offers the advantage that the at least one consumer load can be supplied with a first power L₁. This preferred embodiment offers the advantage that corrective actions can be taken in particular according to Step S6 and/or Step S9 essentially without human interaction, whereby the operational safety of the energy supply apparatus is increased.

A fourth preferred operating method (“Operating Method 4”) includes the following steps:
S13 removing a first amount of energy [J] from a first of said battery modules, preferably in the auxiliary energy supply device, preferably triggered by the monitor device,
S14 delivery a second amount of energy [J] to a second of said battery modules, preferably from the auxiliary energy supply device, preferably triggered by the monitor device, in particular after S13.

Said first amount of energy is preferably repeatedly removed from the first battery module, in particular periodically removed. Said second amount of energy is preferably repeated for the second battery module, in particular periodically delivered.

Steps S13 and/or Step S14 are preferably each performed once every third day, further preferably three times every seventh day, further preferably five times every 14th day. Preferably a resting operating state follows the steps.

The first amount of energy is preferably removed from the battery module during a first time interval. During a later second time interval, the second amount of energy is removed from the second battery module and supplied to the first battery module. Thus the auxiliary energy supply device serves as a temporary buffer store for the first amount of energy.

The first and/or the second amount of energy is preferably understood to mean an electrical charge q [C] which equates to only a fraction r [%] of the rated charge capacity Q_{rated} of the first or second battery module. The fraction r=q/Q_{rated} preferably amounts to at least 0.1%, 0.2%, 0.5%, 1%, 2%, 5%, but not more than 10%.

This preferred operating method offers the advantage that a passivation or a calendar ageing in particular of the cells of at least one of said battery modules can be counteracted. By only low electrical charges being exchanged, only a negligible ageing (cyclic ageing) is associated with the Steps S13 and/or S14. This preferred operating method offers the advantage of an improved availability of the energy supply apparatus.

According to a first preferred further development, the first amount of energy essentially equates to the second amount of energy. This further development offers the advantage that no energy is released into the surroundings.

According to a second preferred further development, the first amount of energy removed from the first battery module is delivered directly to the second battery module. This further development offers the advantage that energy is neither delivered to the auxiliary energy supply device nor to the surroundings.

According to a third preferred further development, the first amount of energy is larger than the second amount of energy. The first amount of energy is removed from the first battery module and delivered to the auxiliary energy supply device. The second amount of energy is removed from the auxiliary energy supply device and delivered to the second battery module. The difference remains in the auxiliary energy supply device. This further development offers the advantage that the auxiliary energy supply device can be charged.

### Application of the Energy Supply Apparatus

According to a first preferred application, an energy supply apparatus according to the invention or one of its further developments is used for the purpose of accommodating energy, in particular electrical energy, from a renewable energy source or electricity mains network, in particular within a first time interval. This preferred application offers the advantage that the energy supply apparatus can accommodate electrical energy as an energy storage buffer.

According to a second preferred application, an energy supply apparatus according to the invention or one of its further developments is used for the delivery of energy, in particular electrical energy, to a mains network or to an in particular static consumer load, in particular within a second time interval. This preferred application offers the advantage that the energy supply apparatus can deliver electrical energy as an energy storage buffer.

According to a preferred further development, an energy supply apparatus according to the invention is used in both ways. Thus the first time interval preferably precedes the second time interval. This preferred further development offers the advantage that the energy supply apparatus can serve as an energy storage buffer.

Further advantages, features and application possibilities of the present invention result from the following description in connection with the figures. In the figures:

FIG. 1 schematically shows an energy supply apparatus according to the invention with battery modules connected in parallel.

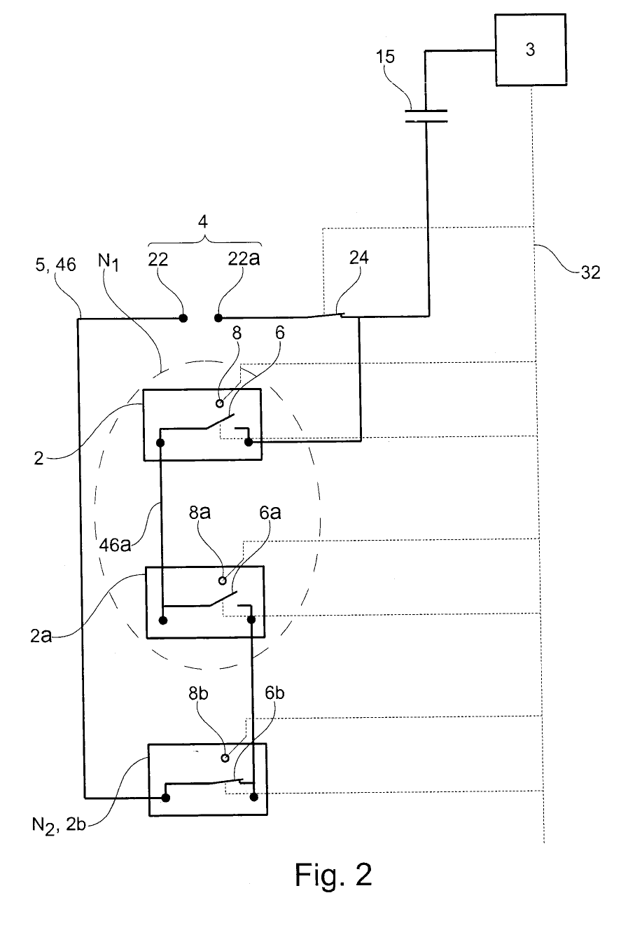

FIG. 2 schematically shows a further energy supply apparatus according to the invention, whose battery modules are connected in series, with an auxiliary energy supply device,

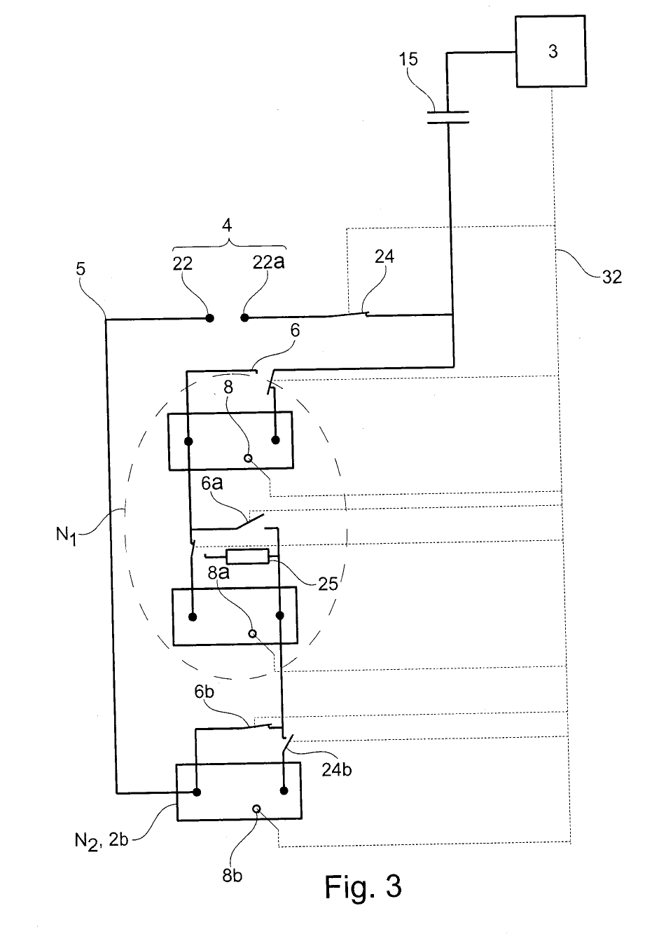

FIG. 3 schematically shows a further development of the energy supply apparatus of FIG. 2 with a plurality of bridging devices and discharge resistors,

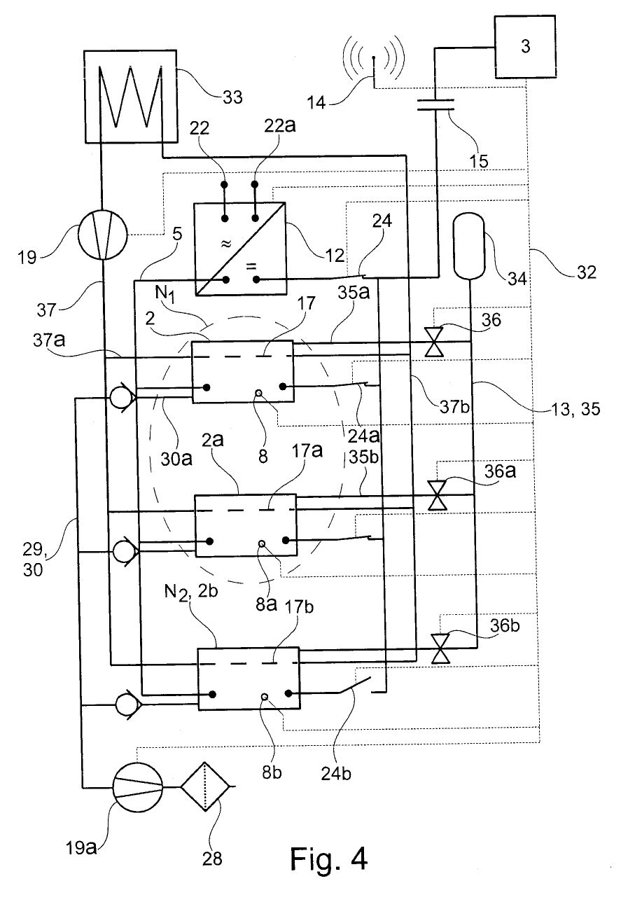

FIG. 4 schematically shows a further development of the energy supply apparatus of FIG. 1, with an extinguishing device, temperature control device, voltage converter, extraction device, auxiliary energy supply device and communication device,

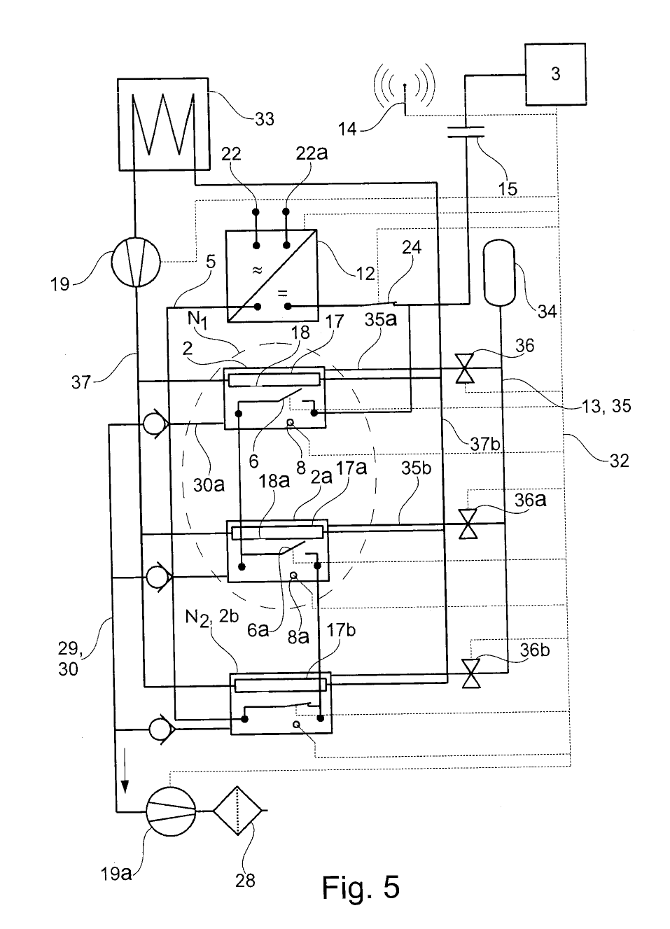

FIG. 5 schematically shows a further development of the energy supply apparatus of FIG. 4, wherein each temperature control device per battery module includes a fluid channel segment with temperature-controlling-fluid vent,

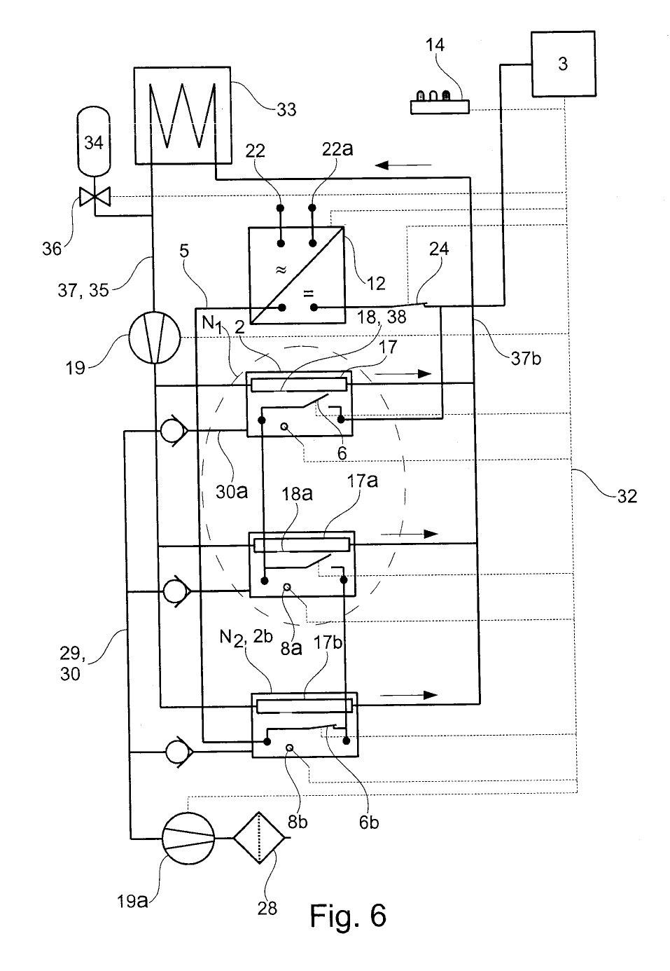

FIG. 6 schematically shows a further development of the energy supply apparatus of FIG. 5, wherein the extinguishing device and the temperature control device are integrally formed, at least in sections.

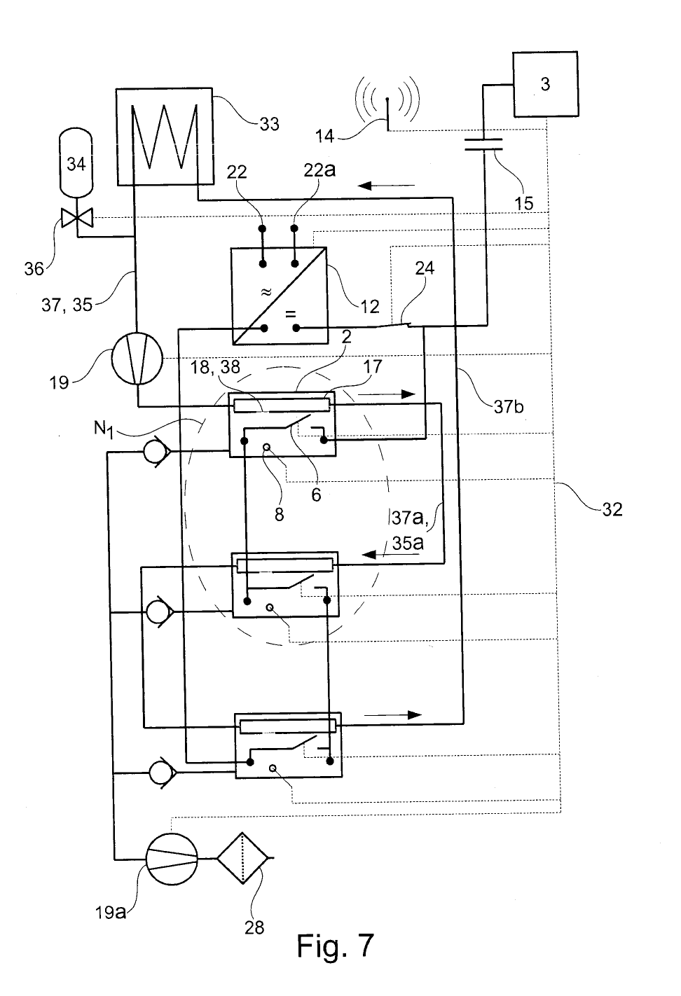

FIG. 7 schematically shows a further development of the energy supply apparatus of FIG. 2, with extinguishing device, temperature control device, voltage converter, extraction device, auxiliary energy supply device and communication device, wherein the extinguishing device and the temperature control device are integrally formed, at least in sections.

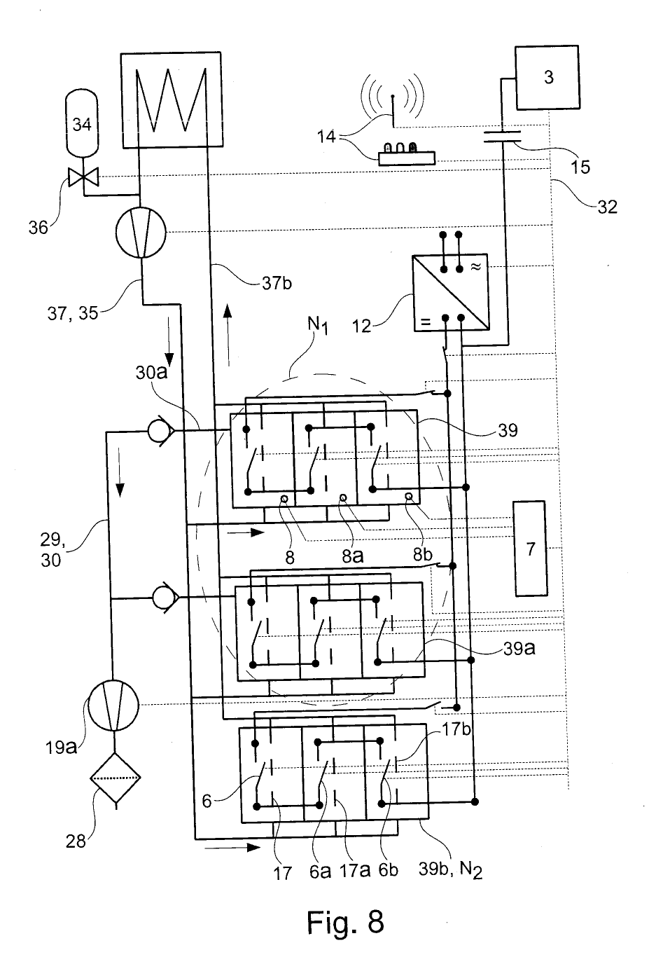

FIG. 8 schematically shows an energy supply apparatus similar to the third preferred embodiment with a plurality of battery module arrays which are electrically connected by means of a second of said electrical switching devices, with an extinguishing device, temperature control device, voltage converter, extraction device, auxiliary energy supply device and communication device, wherein the extinguishing device and the temperature control device are integrally formed, at least in sections,

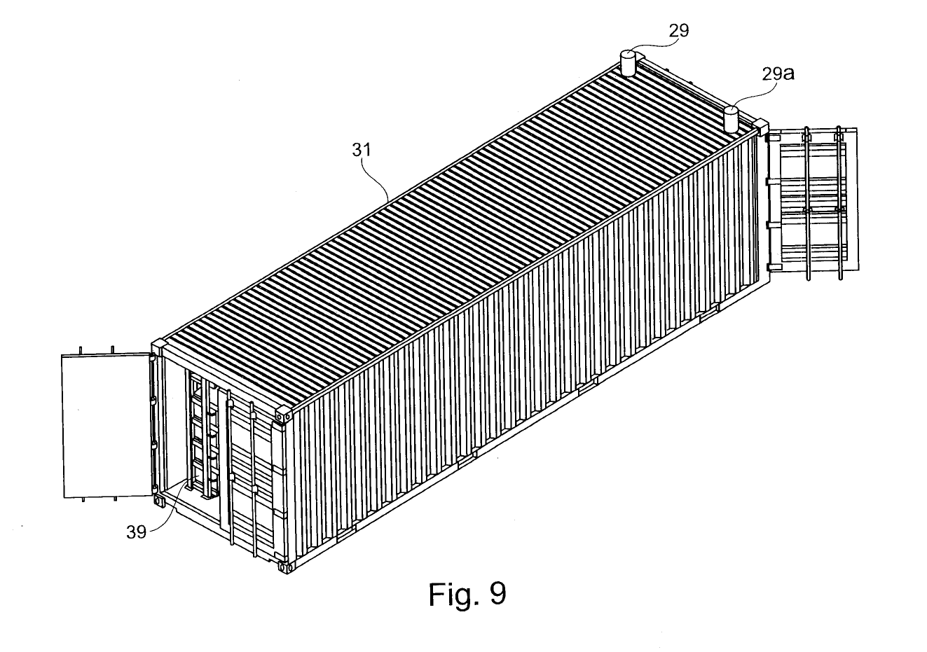

FIG. 9 shows a view from outside the energy supply apparatus according to FIG. 8.

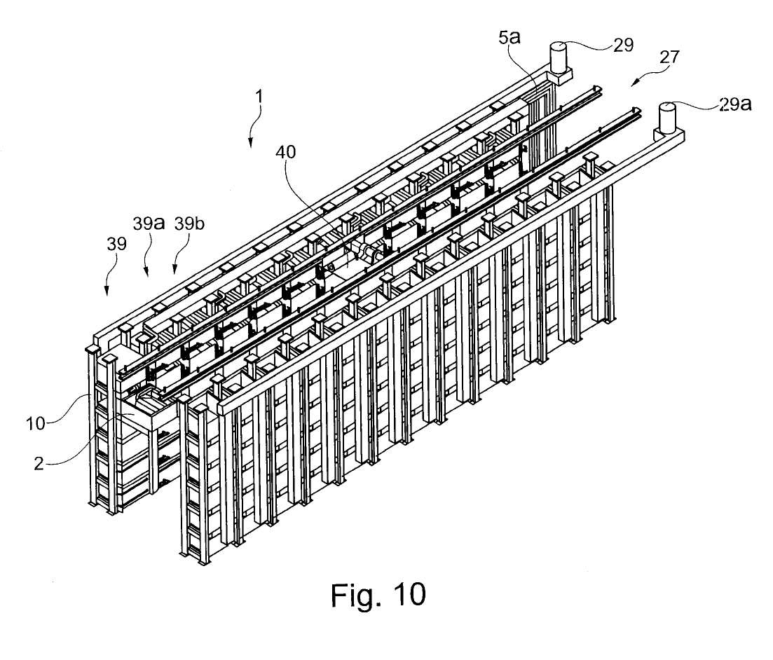

FIG. 10 shows a view of the energy supply apparatus according to FIG. 9, wherein the apparatus container around the devices of the energy supply apparatus is not shown,

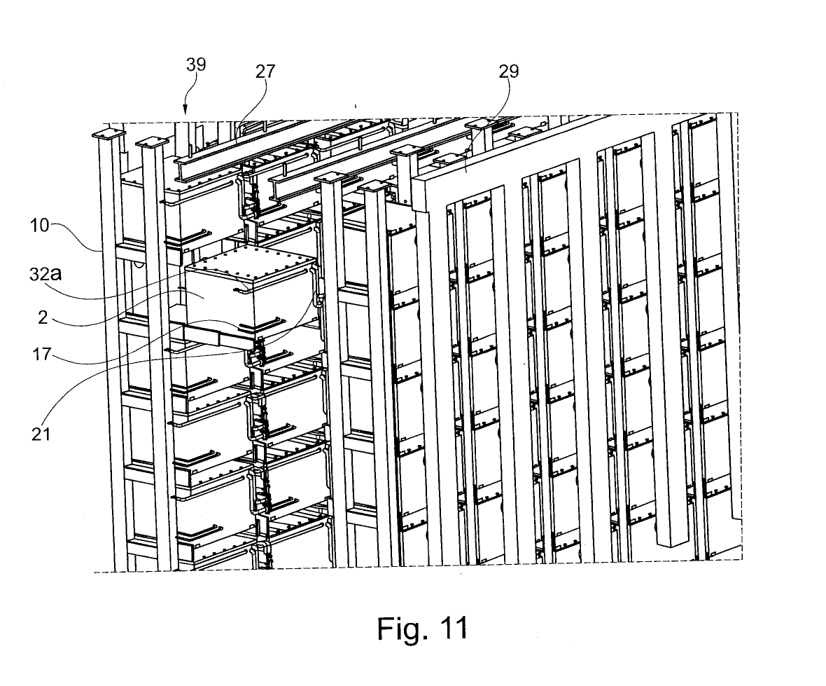

FIG. 11 shows a detail of FIG. 10, wherein one of the battery modules is removed from one of said module accommodation devices,

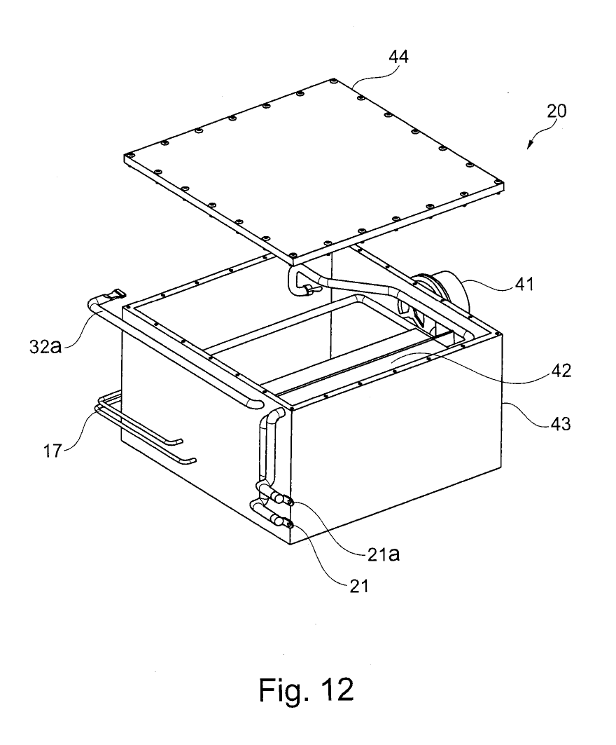

FIG. 12 shows an opened module housing according to a preferred embodiment,

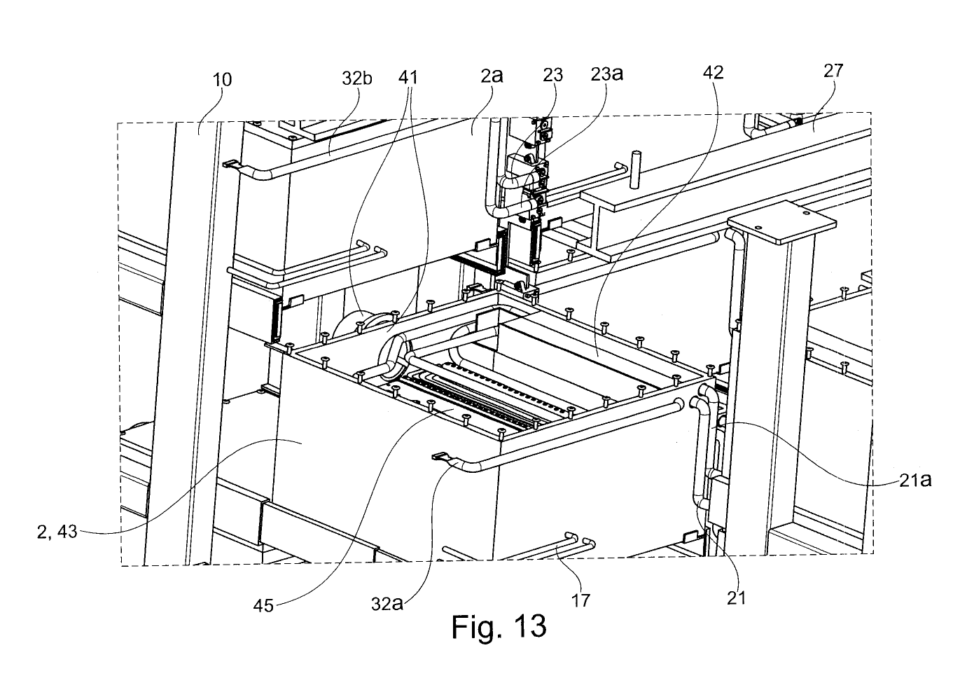

FIG. 13 shows a detail of FIG. 10, wherein the module housing of the removed battery module is open.

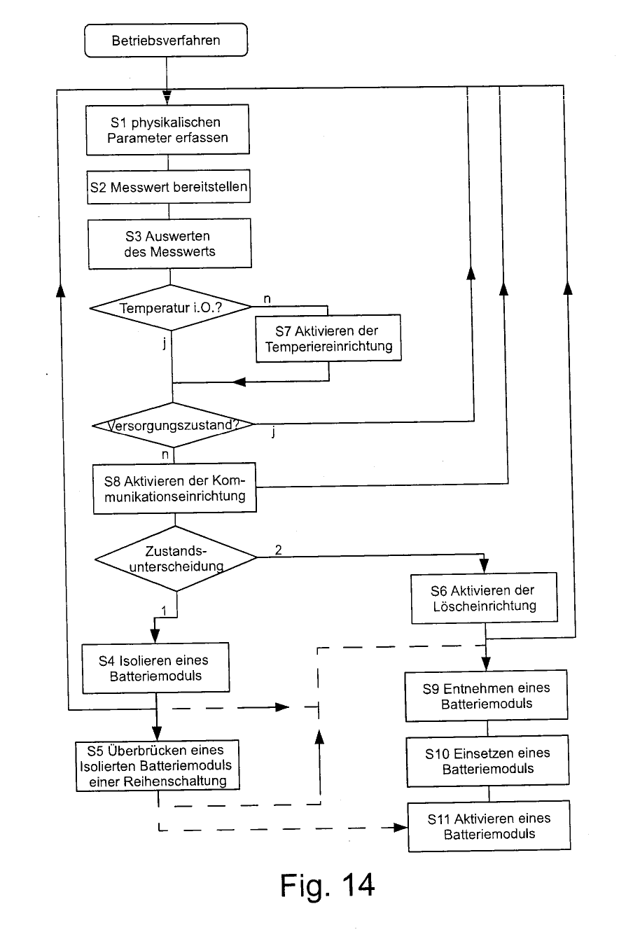

FIG. 14 shows a preferred operating method for the energy supply apparatus as a flow chart,

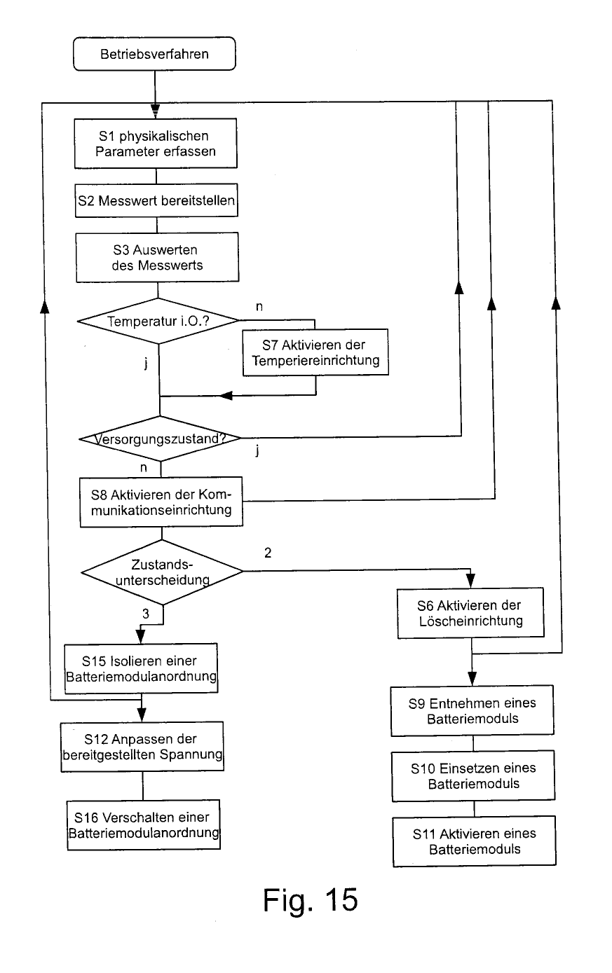

FIG. 15 shows a further preferred operating method for the energy supply apparatus as a flow chart.

FIG. 1 schematically shows an energy supply apparatus 1 according to the invention with battery modules 2, 2a, 2b connected in parallel. The battery modules 2, 2a of the first number are electrically connected to the electrical switching device 5 and to the electrical connection device 4. The battery module 2b of the second number is at this stage isolated from the remaining battery modules 2, 2a and the electrical connection device 4, but when required it can be connected to the remaining battery modules 2, 2a, in particular when commanded by the monitor device 3.

The energy supply apparatus 1 comprises: said electrical connection device 4, to which the electrical switching device 5 is connected, said measuring device 7 comprising one of said measuring probes 8 for each battery module 2, and said monitor device 3. The electrical connection device 4 comprises two of said apparatus terminals 22, 22a of differing polarity, which are at the voltage of the interconnected battery modules 2. The electrical switching device 5 comprises two of said current conducting devices of differing polarity and several of said switching elements 24. Said switching elements 24 can be controlled by the monitor device 3. One of said switching elements 24 is connected between one of said apparatus terminals 22 and one of said current conducting devices. Further switching elements 24a, 24b are connected between the battery module 2 and one of said current conducting devices for the purpose of the isolation, when required, of each battery module 2, 2a, 2b. The switching elements 24 and the measuring probes 8 are connected to the monitor device 3 via a signal bus 32, shown with dashed lines. The measuring probes 8, 8a, 8b serve to detect the module voltage, the module current and/or the module temperature.

FIG. 2 schematically shows a further energy supply apparatus 1 according to the invention. The battery modules 2, 2a of the first number N₁ are connected in series. The battery module 2b of the second number N₂ can be accommodated in this series circuit, in particular when commanded by the monitor device 3, but at this stage is bridged.

The energy supply apparatus 1 comprises: said electrical connection device 4, with which the electrical switching device 5 is connected, said measuring device 7 comprising one of said measuring probes 8, 8a, 8b per battery module 2, said monitor device 3, three of said bridging devices 6, 6a, 6b and said auxiliary energy supply device 15. The electrical connection device 4 has two of said apparatus terminals 22, 22a of differing polarity which are at the voltage of the interconnected battery modules 2, 2a, 2b. The electrical switching device 5 comprises four of said current conducting devices 46, 46a and a switching element 24. Said switching elements 24 and the bridging device 6, 6a, 6b can be controlled by the monitor device. One of said switching elements 24 is connected between one of said apparatus terminals 22a and one of said current conducting devices. The switching elements 24 and the measuring probes 8 are connected to the monitor device 3 via a signal bus 32. The measuring probes 8, 8a, 8b serve to detect the module voltage, the module current and/or the module temperature.

FIG. 3 schematically shows a further development of the energy supply apparatus 1 of FIG. 2 with three bridging devices 6, 6a, 6b. The battery modules 2, 2a of the first number are connected in parallel. The battery module 2b of the second number can be accommodated in this series circuit, in particular when commanded by the monitor device 3, but at this stage is bridged and isolated from the remaining battery modules 2, 2a.

Although only one discharge resistor 25 is shown, each of said bridging devices 6, 6a, 6b comprises its own discharge resistor. The electrical switching device 5 also comprises several of said switching elements 24a, 24b, which each serve to isolate one of said battery modules 2, 2a, 2b.

The remaining corresponds to said further development of FIG. 2.

FIG. 4 schematically shows a further development of the energy supply apparatus 1 of FIG. 1 with said extinguishing device 13, said temperature control device 16, said voltage converter 12, said extraction device 29, auxiliary energy supply device 15 and communication device 14.

The battery modules 2, 2a of the first number are electrically connected to the electrical switching device 5 and to the electrical connection device 4. The battery module 2b of the second number is at this stage isolated from the remaining battery modules 2, 2a and the electrical connection device 4, but when required it can be connected to the remaining battery modules 2, 2a, in particular when commanded by the monitor device 3.

In the following, the differences from the energy supply apparatus of FIG. 1 are described.

The voltage converter 12 is connected between the electrical switching device 5 and the electrical connection device 4 and makes a d.c. voltage available for the supplying of consumer loads. The voltage converter 12 is controlled by the monitor device 3 for the purpose of maintaining the voltage required by the consumer loads, in particular when one of the battery modules 2, 2a, 2b has been isolated from the remaining battery modules 2, 2a, 2b.

The auxiliary energy supply device 15 is connected between the battery modules 2, 2a, 2b and the monitor device 3. The auxiliary energy supply device 15 provides the energy supply to at least the monitor device 3 in the case of an extensive failure of the battery modules 2, 2a, 2b. The auxiliary energy supply device 15 is preferably configured as an electrochemical cell or capacitor.

The communication device 14 is signally connected to the monitor device 3. The communication device 14 transmits, when required, information concerning one of said physical parameters, one of said results of a relation, one of said operating states of one of said battery modules 2, 2a, 2b and/or a corrective action, in particular when commanded by the monitor device 3. The communication device 14 is preferably configured as an interface, or as an acoustic alarm, particularly preferably as a short range device.

The temperature control device 16 comprises a plurality of fluid channel segments 17, 17a, 17b, shown dashed, which extend into various battery modules 2, 2a, 2b, in particular into their module housings 20. The temperature control device 16 comprises a pump 19 for the temperature-controlling fluid and a heat exchanger 33 for exchanging heat with the surroundings. Various temperature-controlling fluid channels 37 connect the fluid channel segments 17 with the pump 19 and the heat exchanger 33. The pump 19 is controlled by the monitor device 3. A central temperature-controlling fluid channel 37 branches out into said fluid channel segments 17, 17a, 17b, so that the temperature of the temperature-controlling fluid, upon entering said fluid channel segments 17, 17a, 17b, has essentially the same temperature.

The extinguishing device 13 comprises: an extinguishing agent store 34, in which the extinguishing agent is pressurized, a plurality of extinguishing agent channels 35, 35a, 35b for connecting the extinguishing agent store 34 with the battery modules 2, 2a, 2b, in particular with their module housings 20 and a plurality of extinguishing agent valves 36 for targeted delivery of the extinguishing agent through the extinguishing agent vents 38 particularly in the walls of the module housings 20. The extinguishing agent valves 36, 36a, 36b can be controlled by the monitor device 3, in particular when at least one of said battery modules 2, 2a, 2b has assumed the failure state.

The extraction device 29 comprises a pump 19a and extraction channels 30 leading to the individual battery modules 2, 2a, 2b. Controlled by the monitor device 3, the pump 19a propels the extracted material through a filter 28, before the extracted material is released to the surroundings. The pump 19a is preferably only activated with a predetermined time delay after activation of the extinguishing device 13, so that the extinguishing agent has time to take effect in the battery module 2, 2a, 2b.

The monitor device 3 is connected, via a signal bus 32 to the switching elements 24 of the electrical switching device 5, the pump 19, 19a from the temperature control device 16 and the extraction device 29, the extinguishing agent valves 36, the voltage converter 12 and the communication device 14.

FIG. 5 schematically shows a further development of the energy supply apparatus 1 of FIG. 4, wherein the temperature control device 16 comprises a fluid channel segment 17 with a temperature-controlling-fluid vent 18 for each battery module 2, 2a, 2b.

Differing from FIG. 4, the battery modules 2, 2a of the first number are connected in series. The battery module 2b of the second number is also a part of said series circuit, but at this stage is bridged.

Differing from FIG. 4, the fluid channel segments 17 of the temperature control device 16 comprise a temperature-controlling-fluid vent 18. The temperature-controlling fluid preferably comprises a gelling agent which promotes an extinguishing effect of the temperature-controlling fluid. The temperature-controlling-fluid vents 18, 18a, 18b can be opened by means of thermostats. Thus the passive safety of the energy supply apparatus 1 is improved.

FIG. 6 schematically shows a further development of the energy supply apparatus 1 of FIG. 5, wherein the extinguishing device 13 and the temperature control device 16 are integrally formed, at least in sections.

Differing from FIG. 5, an extinguishing agent channel 35, which is blocked by a controllable extinguishing agent valve 36, joins with one of the temperature-controlling fluid channels 37. After this joining, the temperature-controlling fluid channel 37 is able to guide not only the temperature-controlling fluid but also the extinguishing agent. Thus the pipework is simplified.

FIG. 7 schematically shows a further development of the energy supply apparatus 1 of FIG. 2, with extinguishing device 13, temperature control device 16, voltage converter 12, extraction device 29, auxiliary energy supply device 15 and communication device 14, wherein the extinguishing device 13 and the temperature control device 16 are integrally formed, at least in sections.

The battery modules 2b of the second number are here also connected with the battery modules 2, 2a of the first number.

The voltage converter 12 is connected between the electrical switching device 5 and the electrical connection device 4 and makes available an a.c. voltage for the supplying of consumer loads. The voltage converter 12 is controlled by the monitor device for maintaining the voltage required by the consumer loads, in particular when one of the battery modules 2, 2a, 2b has been isolated from the remaining battery modules 2, 2a, 2b. At this stage, the voltage converter 12 reduces the total voltage of the interconnected battery modules 2, 2a, 2b to the rated voltage of the consumer loads which are supplied by the energy supply apparatus 1.

The auxiliary energy supply device 15 is connected between the battery modules 2, 2a, 2b and the monitor device 3. The auxiliary energy supply device 15 provides the energy supply to at least the monitor device 3 in the event of an extensive failure of the battery modules 2, 2a, 2b. The auxiliary energy supply device 15 is preferably configured as an electrochemical cell or as a capacitor.

The communication device 14 is signally connected to the monitor device 3. The communication device 14 transmits, when required, information concerning one of said physical parameters, one of said results of a relation, one of said operating states of one of said battery modules 2, 2a, 2b and/or a corrective action, in particular when commanded by the monitor device 3. The communication device 14 is preferably configured as an interface, a means of illumination or as an acoustic alarm, particularly preferably as a short range device.

The temperature control device 16 comprises a plurality of fluid channel segments 17, 17a, 17b, shown dashed, which extend into various battery modules 2, 2a, 2b, in particular into their module housings 20. The temperature control device 16 comprises a pump 19 for the temperature-controlling fluid and a heat exchanger 33 for exchanging heat with the surroundings. The pump 19 is controlled by the monitor device 3. The pump 19 propels the temperature-controlling fluid through the various fluid channel segments 17, 17a, 17b in succession, in the direction of the heat exchanger 33. Thus the pipework is simplified. Each of said fluid channel segments 17 comprises one of said temperature-controlling-fluid vents 18. The temperature-controlling fluid preferably comprises a gelling agent which promotes an extinguishing effect of the temperature-controlling fluid. The temperature-controlling-fluid vents 18 can be opened by the monitor device 3, preferably by means of thermostats. Thus the passive safety of the energy supply apparatus 1 is improved.

The extinguishing device 13 comprises an extinguishing agent store 34 in which the extinguishing agent is pressurized. The extinguishing agent store 34 joins with an extinguishing agent channel 35 which is blocked by a controllable extinguishing agent valve 36. The extinguishing agent channel 35 joins with one of the temperature-controlling fluid channels 37. After this joining, the temperature-controlling fluid channel 37 is able to guide not only the temperature-controlling fluid but also the extinguishing agent. Thus the pipework is simplified. The delivery of the extinguishing agent can be targeted at one of said battery modules 2, 2a, 2b by means of the temperature-controlling-fluid vents.

The extraction device comprises a pump 19a and extraction channels 30 leading to the individual battery modules 2, 2a, 2b. Controlled by the monitor device 3, the pump 19a propels the extracted material through a filter 28 before the extracted material is released to the surroundings. The pump 19a is preferably only activated with a predetermined time delay after activation of the extinguishing device 13, so that the extinguishing agent has time to take effect in the battery module 2, 2a, 2b.

The monitor device 3 is connected via a signal bus 32 to the switching elements 24 of the electrical switching device 5, the pump 19, 19a from the temperature control device 16 and extraction device, the extinguishing agent valves 36, the voltage converter 12 and the communication device 14.

FIG. 8 schematically shows an energy supply apparatus 1 similar to the third preferred embodiment (container or shipping container) with three of said battery module arrays 39, 39a, 39b. Inside said battery module arrays 39, 39a, 39b, the battery modules 2, 2a, 2b are connected in series by means of said first electrical switching device 5. Two of said battery module arrays 39, 39a are connected in parallel by the second electrical switching device 5a. The battery modules 2, 2a, 2b of the third battery module array 39b are at this stage isolated from the remaining battery modules 2, 2a, 2b or battery module arrays 39, 39a, but when required they can be connected to the second electrical switching device 5a. The battery module arrays 39, 39a which are connected to the second electrical switching device 5a preferably comprise only battery modules 2, 2a of the first number and the third battery module array 39b comprises only battery modules 2b of the second number.

Said energy supply apparatus 1 comprises: said voltage converter 12, said extraction device 29, said auxiliary energy supply device 15 and said communication device 14 as shown in FIG. 7.

The temperature control device 16 comprises a central temperature-controlling fluid channel 37, which branches out into a plurality of temperature-controlling fluid channels 37a, 37b which lead to the various battery module arrays 39. Thus the temperature-controlling fluid, upon entering the battery modules 2, 2a, 2b of the various battery module arrays 39, has essentially the same temperature. For each battery module array 39, each one of said temperature-controlling fluid channels 37a, 37b branches out into at least one of said fluid channel segments 17, shown dashed, which extend into various battery modules 2, 2a, 2b, in particular into their module housings 20. The temperature control device 16 comprises a pump for the temperature-controlling fluid and a heat exchanger 33 for exchanging heat in particular with the surroundings. Various temperature-controlling fluid channels 37 connect the fluid channel segments 17 with the pump 19 and the heat exchanger 33. The pump 19 is controlled by the monitor device 3. Each of said fluid channel segments 17 comprises one of said temperature-controlling-fluid vents 18. The temperature-controlling fluid preferably comprises a gelling agent which promotes an extinguishing effect of the temperature-controlling fluid. The temperature-controlling-fluid vents 18 can be opened by the monitor device 3. The temperature-controlling-fluid vents 18 can preferably be opened by means of thermostats. Thus the passive safety of the energy supply apparatus 1 is improved.

The extinguishing device 13 comprises an extinguishing agent store 34 in which the extinguishing agent is pressurized. The extinguishing agent store 34 joins with an extinguishing agent channel 35 which is blocked by a controllable extinguishing agent valve 36. The extinguishing agent channel 35 joins with one of the temperature-controlling fluid channels 37, in particular with the central temperature-controlling fluid channel. After this joining, the central temperature-controlling fluid channel 37 is able to guide not only the temperature-controlling fluid but also the extinguishing agent. Thus the extinguishing device 13 and the temperature control device 16 are integrally formed, at least in sections, and the pipework is simplified. The delivery of the extinguishing agent by the temperature-controlling-fluid vents 18 can be targeted at one of said battery modules 2, 2a, 2b.

FIG. 9 shows a view from outside the energy supply apparatus 1 according to FIG. 8. The apparatus container 31 is configured as a container, in particular a shipping container and surrounds said battery module arrays 39. Outlets of the extraction device 29 extend from the apparatus container 31. One of said battery module arrays 39 is visible through the open door of the shipping container. One of said battery module arrays 39 comprises a module accommodation device 10 which is configured as a rack, and comprises shelves for the battery modules 2. The shelves for the battery modules 2 are arranged one above the other and comprise pull-out support surfaces. The battery modules 2 are connected with one another by said first electrical switching device 5. The battery modules 2 comprise module housings 20.

Not shown are a heat exchanger 33 for the temperature control device 16 and a heat exchanger for cooling the current conducting devices 46 of the second electrical switching device 5a and/or of the apparatus terminals 22 of the electrical connection device 4.

FIG. 10 shows a view of the energy supply apparatus 1 according to FIG. 9 wherein the apparatus container 31 around the battery module arrays 39, 39a, 39b is not shown.

The battery module arrays 39, 39a, 39b are positioned next to one another in two rows. Within the battery module arrays 39, 39a, 39b a plurality of said battery modules 2, 2a, 2b are each connected by means of a first electrical switching device 5. Each of said battery module arrays 39, 39a, 39b comprises a module accommodation device 10 with shelves and pull-out support surfaces for the battery modules 2, 2a, 2b.

Said first electrical switching devices 5 are connected with a second electrical switching device 5a. The second electrical switching device 5a is connected to the electrical connection device 4, not shown. The voltage converter 12 is not shown.

The module exchange device 27 is positioned between said rows of battery module arrays 39, 39a, 39b. The module exchange device 27 is assembled here on the ceiling of the apparatus container 31. The module exchange device 27 comprises two transport rails for said grab 40. The grab 40 is configured to collect one of said battery modules 2, 2a, 2b which is ready to be removed by means of the pull-out support surfaces. As soon as the battery module 2, 2a, 2b is made ready for removal by means of the pull-out support surfaces, the module terminals 21, 21a are separated from the first electrical switching device 5. Furthermore, the quick couplings for the temperature-controlling fluid channels 37 and the extinguishing agent channels 35 are also separated. Furthermore, the measuring probes 8, which are connected with the module housing 20, are separated from the signal bus 32.

For each row of battery module arrays 39, 39a, 39b, the energy supply apparatus 1 comprises an extraction device 29, 29a. Said extraction devices 29, 29a are connected with the individual battery modules 2, 2a, 2b and lead to the outside. The fluid cleaning device 28 is not shown.

Not shown are the examination area and the module container, which are adjacent to the rows of battery module arrays 39, 39a, 39b within reach of the module exchange device 27.

FIG. 11 shows a detail of FIG. 10, wherein one of the battery modules 2 is removed from one of said module accommodation devices 10. The battery module 2 is pulled out by means of the pull-out support surfaces from the shelf of the module accommodation device 10, wherein the module terminals 21, the fluid channel segment 17, the pressure relief device 41 and the signal leads 32a leading to the measuring probes are separated. Said battery module 2 is in range of the module exchange device 27 and is prepared for picking up by the grab 40.

The module exchange device 27 is positioned at the ceiling of the apparatus container and comprises two rails for guiding the grab 40.

FIG. 12 shows an opened module housing 20 according to a preferred embodiment. The module housing 20 comprises a module box 43 and a module lid 44. The module lid 44 can be screwed to the module box 43. Not shown is the gasket between the module lid 44 and the module box 43. The present module housing 20 is constructed from sheet metal.

At the module box 43, there are arranged: the signal leads 32a to the measuring probes 8, the fluid channel segment 17, the pressure relief device 41 and the module terminals 21, 21a. The cable shelf 42 is visible through the opening of the module box 43 and serves in particular the accommodation of electrical leads for connecting the interconnected cells with the module terminals 21.

The pressure relief device 41 comprises an opening in one of the walls of the module box 43 and a self-closing outlet valve in said opening.

FIG. 13 shows a detail of FIG. 10 and/or FIG. 11, wherein the module housing 20 of the battery module 2, which has been removed from the module accommodation device 10, is open.

At the module box 43, there are arranged: the signal leads 32a to the measuring probes 8, the fluid channel segment 17, the pressure relief device 41 and the module terminals 21, 21a. The cable shelf 42 is visible through the opening of the module box 43. The cell connection device 45 for interconnecting the cells of the battery module 2 is visible through the opening of the module box 43.

The pressure relief device 41 comprises an opening in one of the walls of the module box 43 and a self-closing outlet valve in said opening.

The module exchange device 27 is positioned at the ceiling of the apparatus container and comprises two rails for guiding the grab 40.

A further battery module 2a is shown above the battery module 2. Its signal leads 32b are routed to the module accommodation device 10. The signal bus 32 runs within a vertical support of the module accommodation device 10. The module terminals of the above lying battery module 2a are connected with the associated module terminal elements 23, 23a.

FIG. 14 shows a preferred operating method for the energy supply apparatus as a flow chart.

First at least one physical parameter of at least one of said battery modules is detected according to Step S1. The measuring device provides at least one corresponding measurement value according to Step S2.

The monitor device evaluates said measurement value according to Step S3. Provided the temperature of the associated battery module lies outside permitted limits, the temperature control device is activated by the monitor device according to Step S7. Provided the evaluation of the measurement value indicates that the battery module is no longer in the supply state, the monitor device activates the communication device according to Step S8.

A decision between various operating states of the battery module takes place wherein said decision is dependent upon the result of the evaluation according to Step S3 and in particular dependent on the detected physical parameter. Two possible corrective actions are shown. The measuring of physical parameters, according to Step S1, is preferably resumed during and after the taking of corrective actions, for increased operational safety of the energy supply apparatus.

Corrective Action 1, in particular taken in the event of an operational state which is no longer dangerous to the surroundings, particularly preferably in the event of advanced ageing of the battery module, comprises an electric isolating of the battery module according to Step S4. Following this, the isolated battery module can be bridged according to Step S5, in particular when the battery module is part of a series circuit. The bridged battery module can, according to Step S9, be removed and/or a further battery module can, according to Step S10, be replaced and activated according to Step S11.

Corrective Action 2, in particular taken in the event of an exceeded upper temperature limit, presence of an oxidation product and/or smoke, comprises an activating of the extinguishing device according to Step S6. The battery module can be removed according to Step S9 and/or a further battery module can be replaced according to Step S10 and activated according to Step S11.

FIG. 15 shows a further preferred operating method for a preferred embodiment of the energy supply apparatus in the form of a flow chart. For this further operating method, the energy supply apparatus comprises a plurality of said battery module arrays. Preferably at least one of said battery module arrays or its battery modules serves the purpose of providing the power ΔL. The energy supply apparatus preferably comprises at least one of said voltage converters, which particularly preferably is connected between the second electrical switching device and the electrical connection device.

First at least one physical parameter of at least one of said battery modules is detected according to Step S1. The measuring device provides at least one corresponding measurement value according to Step S2.

The monitor device evaluates said measurement value according to Step S3. Provided the temperature of the associated battery module lies outside permitted limits, the temperature control device is activated by the monitor device according to Step S7. Provided the evaluation of the measurement value indicates that the battery module is no longer in the supply state, the monitor device activates the communication device according to Step S8.

A decision between various operating states of the battery module takes place wherein said decision is dependent upon the result of the evaluation according to Step S3 and in particular dependent on the detected physical parameter. Two possible corrective actions are shown. The measuring of physical parameters, according to Step S1, is preferably resumed during and after the taking of corrective actions, for increased operational safety of the energy supply apparatus.

Corrective Action 2, in particular taken in the event of an exceeded upper temperature limit, presence of an oxidation product and/or smoke, comprises an activating of the extinguishing device according to Step S6. The battery module can be removed according to Step S9 and/or a further battery module can be replaced according to Step S10 and activated according to Step S11.

Corrective Action 3, in particular taken in the event of a serious malfunction of one of the battery module arrays, particularly preferably when an exceeded upper temperature limit, an oxidation product and/or smoke has been detected for a plurality of said battery modules, comprises the isolation of at least one of said battery module arrays according to Step S15.

Step S12 is preferably executed in a temporal relationship with, particularly preferably essentially simultaneously with, Step S15, particularly preferably when, as a consequence of Step S15, the electrical voltage supplied by the battery modules is lower than the voltage required by the supplied consumer loads. As a consequence the electrical voltage supplied by the interconnected battery modules is converted to suit the voltage required by the supplied consumer loads.

Step S16 is preferably executed in a temporal relationship with, particularly preferably essentially simultaneously with Step S15, particularly preferably when, as a result of step S15, said electrical power delivered by the battery modules, i.e. their total electrical power, is lower than the voltage required by the supplied consumer loads. As a consequence, the consumer loads can be uninterruptedly supplied with the first power L₁.

### LIST OF REFERENCE NUMBERS

1 energy supply apparatus
2, 2a, 2b battery module
3 battery module monitor device, monitor device
4 electrical connection device
5, 5a, 5b electrical switching device
6, 6a, 6b bridging device
7 measuring device
8, 8a, 8b measuring probe
9 probe switcher
10 module accommodation device
11 thermal protection device
12 voltage converter
13 extinguishing device
14 communication device
15 auxiliary energy supply device
16 temperature control device
17, 17a, 17b fluid channel segment
18, 18a temperature-controlling-fluid vent
19, 19a fluid conveying device
20, 20a, 20b module housing
21, 21a module terminal
22, 22a apparatus terminal
23, 23a module terminal element
24, 24a, 24b switching element
25 discharge resistor
26 data storage means
27 module exchange device
28 fluid cleaning device
29, 29a extraction device
30, 30a extraction channel
31 apparatus container
32, 32a, 32b signal bus, signal leads
33 heat exchanger
34 extinguishing agent store
35, 35a, 35b extinguishing agent channel
36, 36a, 36b extinguishing agent valve
37, 37a, 37b temperature-controlling fluid channel
38 extinguishing agent vent
39, 39a, 39b battery module array
40 grab
41 pressure relief device
42 cable shelf
43 module box
44 module lid
45 cell connection device
46, 46a current conducting device

1. An energy supply apparatus which is provided to supply one or a plurality of consumer loads, at least temporarily, with a first power L₁, which comprises:
a first number N₁ of battery modules, each of which comprises at least one, electrochemical cell wherein the number N₁ is chosen so that, taking into account the power of each battery module, a total electrical power is deliverable to the consumer load, wherein said total electrical power is at least equal to said first power L₁,
a second N₂ of battery modules, each of which comprises at least one electrochemical cell, wherein the number N₂ is to be chosen so that, taking into account the power of each battery module, a total electrical power is deliverable to the consumer load, wherein said total electrical power is at least equal to a power ΔL.
a battery module monitor device which monitors at least one physical parameter, wherein at least two different operating states of a battery module are detectable by said physical parameter.
an electrical connection device to electrically connect the first number N₁ and the second number N₂ of battery modules with one or a plurality of consumer loads, and
an electrical switching device, by which said battery modules can be connected in series and/or in parallel with said electrical connection device, wherein said electrical switching device is designed so that each battery module is electrically isolatable from the other battery modules and/or the electrical connection device when said monitor device recognizes that said physical parameter, of which at least one is detected for each battery module, is outside a predefined range, and if required:
a bridging device to electrically bridge an isolated battery module,
wherein the number N₂ and the power of said second number of battery modules is chosen so that said first power L₁ is deliverable to the consumer load or loads even when a predefined number N_{D} of said first number or said second number of battery modules fails.

2. The energy supply apparatus according to claim 1, having at least one of the following devices:
a measuring device which is designed to detect at least one of said physical parameters, which is designed for the provision of at least one measurement value wherein said measurement value is representative of the detected physical parameter, wherein said measuring device comprises at least one measuring probe,
a module accommodation device which is designed to accommodate at least one of said battery modules, in or is designed to accommodate, at least temporarily, all of said battery modules,
a thermal protection device which is designed to counteract an exchange of heat between two adjacent said battery modules.

3. The energy supply apparatus according to claim 1, wherein the monitor device is designed to operate one of said electrical switching devices, wherein the monitor device is designed to receive at least one of said measurement values, or wherein the monitor device is designed to activate one of said bridging devices.

4. The energy supply apparatus according to claim 1, comprising at least one voltage converter which is connected between at least one of said battery modules and the electrical connection device and is designed to provide, at least temporarily, a predetermined d.c. voltage or predetermined a.c. voltage.

5. The energy supply apparatus according to claim 1, including at least one extinguishing device which serves to counteract a fire of at least one of said battery modules and which is designed to deliver at least temporarily an extinguishing agent.

6. The energy supply apparatus according to claim 1, including a communication device which is designed to communicate or transmit at least one of said physical parameters, or which is designed to communicate or transmit the fact that at least one of said detected physical parameters lies outside a predefined range.

7. The energy supply apparatus according to claim 1, including an auxiliary energy supply device which is designed to supply with electrical energy, at least temporarily, at least one of said monitor devices, at least one of said measuring devices at least one of said extinguishing devices and/or one of said communication devices.

8. Energy supply apparatus according to claim 1, including one temperature control device which is designed to at least temporarily dissipate heat from at least one of said battery modules.

9. The energy supply apparatus according to claim 8 wherein
the at least one extinguishing device comprises at least one extinguishing agent channel, wherein said extinguishing agent channel is designed to guide said extinguishing agent, and/or
the at least one temperature control device comprises at least one temperature-controlling fluid channel, wherein said temperature-controlling fluid channel is designed to guide said temperature controlling fluid.

10. The energy supply apparatus according to claim 1, wherein
at least one of said battery modules is bounded from its environment by a module housing, wherein said module housing is designed to counteract an uncontrolled exit of a substance from said battery module into the environment.

11. The energy supply apparatus according to claim 1, including
at least two battery module arrays, each of which having a first of said electrical switching devices, wherein said module arrays comprise a plurality of battery modules, wherein said battery modules can be connected to each other in parallel and/or in series by said first electrical switching device,
a second of said electrical switching devices which can be connected to said electrical connection device, which can be connected to said battery module arrays.

12. The energy supply apparatus according to claim 1, with
a module container which is designed for the accommodation of one of said battery modules or which is designed for the accommodation of failed battery module, or which is able to counteract an exit of a material of the accommodated battery module, of an oxidation product and/or smoke into the surroundings of the module container, and/or.

13. (canceled)

14. The energy supply apparatus according to claim 1, wherein one of said battery modules includes at least one electrochemical cell, wherein said cell includes a separator which does not conduct electrons or does so only weakly, and which comprises an at least partially permeable substrate, whereby said substrate is coated with an inorganic material, wherein an organic material is designed as a non-woven fabric.

15. A method for the operation of an energy supply apparatus according to claim 1, comprising the following:
S1 detecting one of said physical parameters, or detecting a physical parameter concerning one of said battery modules, by said measuring device, or by at least one of its measuring probes,
S2 providing one of said measurement values by one of said measuring devices,
S3 evaluating or processing at least one of said measurement values by the monitor device, or relating said measurement value with a comparison value or with one of said predefined ranges,
S4 isolating at least one of said battery modules from the remaining battery modules by one of said electrical switching devices, or by opening one of said switching elements of said electrical switching device,
S5 bridging an in particular isolated one of said battery modules or an isolated one of said battery modules with one of said bridging devices,
S6 activating the temperature extinguishing device, whereupon the extinguishing agent is delivered to at least one of the battery modules,
S7 activating the temperature control device, whereupon heat energy is exchanged with at least one of said battery modules,
S8 activating the communication device, whereupon one of said physical parameters or a relationship is communicated,
S9 removing one of said battery modules from the energy supply apparatus, or from said module accommodation device,
S10 installing one of said battery modules in said module accommodation device, in
S11 activating one of said battery modules,
S12 adjusting the voltage provided by the connected battery modules, or converting a provided d.c. voltage to an a.c. voltage, or decreasing the provided d.c. voltage, or decreasing the provided d.c. voltage to an a.c. voltage by said voltage converter, for the purpose of supplying consumer loads which are driven by means of an a.c. voltage,
S15 isolating at least one of said battery module arrays, or at least one of its/their battery modules, or its/their first electrical switching device from the remaining battery module arrays by means of one of said switching elements of the second electrical switching device,
S16 connecting one of said battery module arrays with the second electrical switching device by one of said switching elements of the second electrical switching device.

16. The method according to claim 15, comprising:
S1, S2, S3, and
S4.

17. The method according to claim 15, comprising:
S1, S2, and S3, and
S15.

18. The method according to claim 15, further comprising:
S13 removing of a first amount of energy [J] from a first of said battery modules, or removing of a first amount of energy [J] from a first of said battery modules to the auxiliary energy supply device,
S14 delivering a second amount of energy [J] to a second of said battery modules, or
delivery of a second amount of energy [J] to a second of said battery modules from the auxiliary energy supply device.

19. An application of an energy supply apparatus according to claim 1
for the receiving of energy from a regenerative energy source or from an electricity grid, in particular within a first time interval and/or
for the supplying of energy to an in particular static consumer load or an electricity grid, in particular within a second time interval.

20. The energy supply apparatus according to claim 2, wherein the thermal protection device is positioned between said adjacent battery modules or inside the module accommodation device.

21. The energy supply apparatus according to claim 2, comprising at least one of said measuring devices, one of said electrical switching devices and said module accommodation device.

22. The energy supply apparatus according to claim 4, wherein said voltage converter is bidirectional and is designed to at least temporarily provide a predetermined charging voltage or a predetermined charging current for the purpose of charging of at least one of said battery modules.

23. The energy supply apparatus according to claim 5, wherein the at least one extinguishing device is designed to deliver at least temporarily an extinguishing agent to one of said battery modules when said monitor device recognizes that said physical parameter, of which at least one is detected for each battery module, is outside a predefined range.

24. The energy supply apparatus according to claim 8, wherein the temperature control device is designed to dissipate heat from at least one of said battery modules or to deliver a temperature controlling fluid to said battery module, when said monitor device recognizes that said physical parameter, of which at least one is detected for each battery module, is outside a predefined range.

25. The energy supply apparatus according to the claim 9, wherein the at least one temperature-controlling fluid channel is integrally formed with said at least one extinguishing agent channel, at least in sections.

26. The energy supply apparatus, according to claim 10, wherein at least one of said measuring probes is accommodated in said module housing, or wherein one of said extinguishing devices is designed to deliver the extinguishing agent at least temporarily into said module housing.

27. The energy supply apparatus, according to claims 10, wherein said measuring probe is designed for detecting an oxidation product and/or smoke and/or for measuring a temperature of the battery module.

28. The energy supply apparatus, according to one of claims 10, wherein one of said extinguishing devices is designed to deliver the extinguishing agent at least temporarily into said module housing, when the measuring probe detects an oxidation product and/or smoke.

29. The energy supply apparatus according to claim 11, comprising one of said voltage converters, which is connected between the second electrical switching device and said electrical connection device.

30. The energy supply apparatus according to any one of claim 11, comprising one of said measuring devices, one of said extinguishing devices, one of said temperature control devices, one of said communication devices and/or one of said auxiliary energy supply devices.

31. The energy supply apparatus according to claim 1, further comprising a module exchange device which is designed to remove an in particular isolated and/or defective one of said battery modules of one of said module accommodation devices, and which is designed to install one of said battery modules in one of said module accommodation devices.

32. The method according to claim 15, wherein at least one of S9 or S10 is executed by the module exchange device.

33. The method according to claim 16, comprising S6, S7 and/or S8.

34. The method according to claim 15, wherein at least one of S4, S5, S6, S7, S8 or S15 is executed when said monitor device recognizes that said physical parameter, of which at least one is detected for each battery module, is outside one of said predefined ranges.

35. The method according to claim 17, comprising at least one of S8, S12 and S16.

36. The method according to claim 18, wherein at least one of S13, S14 is triggered by the monitor device.

37. The application according to claim 19,
for the receiving of electrical energy from a regenerative energy source or from an electricity grid, within a first time interval, and/or
for the supplying of electrical energy to a consumer load or an electricity grid, within a second time interval,
whereby the first time interval precedes the second time interval.
